(19) United States
(12) Patent Application Publication
(10) Pub. No.: US 2025/0332576 A1
(43) Pub. Date: Oct. 30, 2025

(54) PROCESS OF SYNTHESIS OF GRAPHENE OXIDE QUANTUM DOTS-IRON PHTHALOCYANINE (FEPC-GOQDS) NANOCOMPOSITE COMPOSITION

(71) Applicant: PRINCESS NOURAH BINT ABDULRAHMAN UNIVERSITY, Riyadh (SA)

(72) Inventors: Anuj KUMAR, Mathura (IN); Mohd UBAIDULLAH, Riyadh (SA); Hari Mohan SHARMA, Mathura (IN); Thamraa ALSHAHRANI, Riyadh (SA); Mohdmmad KHALID, Glasgow (GB); Yufeng ZHO, Shanghai (CN); Mohd. SHKIR, Abha (SA); Ibragimov Aziz BAKHTIYAROVICH, Tashkent (UZ)

(73) Assignee: PRINCESS NOURAH BINT ABDULRAHMAN UNIVERSITY, Riyadh (SA)

(21) Appl. No.: 19/264,691

(22) Filed: Jul. 9, 2025

(51) Int. Cl. B01J 23/745; B01J 35/45; B01J 35/61; B01J 37/10; B01J 37/32; B82Y 30/00

(52) U.S. Cl. CPC B01J 23/745; B01J 35/45; B01J 35/615; B01J 37/10; B01J 37/32; B01J 2235/15; B01J 2235/30; B82Y 30/00

(57) ABSTRACT

The present invention generally relates to a process for synthesizing a graphene oxide quantum dots-iron phthalocyanine (FePc-GOQDs) nanocomposite with enhanced electrochemical properties, particularly for oxygen reduction reactions (ORR). The process begins by dispersing 500 mg of graphene oxide (GO) in a hydrogen peroxide and deionized water solution in a 1:10 volume ratio, followed by hydrothermal treatment at 180° C. for 8 hours to produce GO quantum dots (GOQDs). The resulting material is freeze-dried to obtain GOQDs powder. Subsequently, 60 mg of GOQDs are combined with 10 mg of iron phthalocyanine (FePc) and 20 mL of dimethyl sulfoxide (DMSO), and the mixture is subjected to microwave irradiation at 500 W and 150° C. for 30 minutes. The resulting composite is rinsed repeatedly with deionized water and ethanol, then dried at 120° C. to yield the FePc-GOQDs nanocomposite. This composite demonstrates superior ORR performance due to strong Fe—O bonding and optimized electronic interactions.

### FIELD OF THE INVENTION

The present disclosure relates to the field of nanomaterials and electrochemical catalysis. More particularly, it pertains to a graphene oxide quantum dots-iron phthalocyanine (FePc-GOQDs) nanocomposite composition and a process for synthesizing the same. The invention is specifically directed toward the development of advanced nanocomposites with enhanced catalytic activity for applications such as oxygen reduction reactions (ORR) in fuel cells, metal-air batteries, and other energy conversion and storage devices.

### BACKGROUND OF THE INVENTION

The urgent demand for cutting-edge energy conversion and storage solutions has become increasingly critical, driven by the global shift toward sustainable and renewable energy technologies. As the world transitions to greener and more efficient energy systems, the development of high-performance, cost-effective materials capable of supporting this transformation is essential. Among various electrochemical processes, the oxygen reduction reaction (ORR) plays a pivotal role as the key cathodic reaction in fuel cells and metal-air batteries. However, the intrinsically slow kinetics of ORR significantly limit the overall efficiency of these energy devices.

Platinum-based catalysts, known for their high catalytic activity, have been widely used for ORR but face major drawbacks, including high cost, scarcity, and operational instability. These limitations have spurred extensive research into alternative materials. Iron phthalocyanine (FePc) has emerged as a promising non-precious metal catalyst owing to its unique molecular structure and active ORR sites. Nonetheless, FePc suffers from poor electrical conductivity and a tendency for active site aggregation, which restricts its practical application.

To overcome these challenges, researchers have explored hybridizing FePc with conductive nanomaterials. Graphene oxide quantum dots (GOQDs), with their high surface area, excellent conductivity, and tunable electronic properties, offer an ideal support material to enhance FePc performance. This invention builds on the synergistic integration of GOQDs with FePc to engineer a nanocomposite that improves ORR catalytic activity while mitigating the inherent limitations of FePc. The resulting FePc-GOQDs composite has the potential to contribute significantly to the advancement of renewable energy technologies by providing an efficient, low-cost alternative for electrochemical energy systems.

### SUMMARY OF THE INVENTION

The present disclosure seeks to provide a graphene oxide quantum dots-iron phthalocyanine (FePc-GOQDs) nanocomposite composition and its synthesis process. This invention pertains to the creation of a novel composite material, graphene oxide quantum dots-iron phthalocyanine (GOQDs-FePc), which is intended to improve the performance of oxygen reduction reaction (ORR) in fuel cells. The combination of GOQDs and FePc takes advantage of the unique features of GOQDs and FePc individually, enhancing catalytic ORR performance. The creation of Fe—O bonds between the oxygen-containing groups in GOQDs and the iron centre of FePc is an important part of the study since it changes the catalyst's electronic structure and improves its functioning. The structural and electrical properties of the GOQDs-FePc composite was determined by combining advanced spectroscopic techniques with density functional theory (DFT) simulations. These investigations demonstrated improved electronic interactions, faster electron transfer rates, and a changed energy landscape, which synergistically improved the ORR performance of FePc. The results showed that the GOQDs-FePc composite not only displayed excellent ORR activity, but also exhibited better stability and methanol tolerance, as compared to bare FePc and 20% Pt/C catalysts. The present invention revealed the potential of GOQDs-FePc as a high-efficiency electrocatalyst, paving the way for the development of novel energy materials with a substantial impact on future renewable energy technologies.

In an embodiment, a graphene oxide quantum dots-iron phthalocyanine (FePc-GOQDs) nanocomposite composition is disclosed. The composition comprising: 60 mg of graphene oxide quantum dots (GOQDs); 10 mg of iron phthalocyanine (FePc); and 20 mL of dimethyl sulfoxide (DMSO).

In another embodiment, a process for synthesizing a graphene oxide quantum dots-iron phthalocyanine (FePc-GOQDs) nanocomposite is disclosed. The process includes producing graphene oxide quantum dots (GOQDs) upon treating 500 mg of graphene oxide (GO) in a solution comprising hydrogen peroxide (H₂O₂) and deionized water in a 1:10 volume ratio.

The process further includes freeze-drying the resultant GOQDs to obtain GOQDs powder.

The process further includes mixing 60 mg of the GOQDs powder with 10 mg of iron phthalocyanine (FePc) and 20 mL of dimethyl sulfoxide (DMSO).

The process further includes subjecting the mixture to microwave irradiation at a power of 500 W and a temperature of approximately 150° C. for 30 minutes in a microwave synthesizer to form a nanocomposite.

The process further includes rinsing the obtained slurry with deionized water and ethanol multiple times.

The process further includes drying the rinsed material at approximately 120° C. for an extended duration to yield the FePc-GOQDs nanocomposite.

An object of the present disclosure is to provide a novel and efficient process for synthesizing a graphene oxide quantum dots-iron phthalocyanine (FePc-GOQDs) nanocomposite that demonstrates superior performance in the oxygen reduction reaction (ORR), which is crucial for fuel cells and metal-air batteries.

Another object of the present disclosure is to develop a hybrid nanocomposite material comprising uniformly dispersed GOQDs and FePc nanocrystals to enhance electrocatalytic efficiency through increased active site accessibility and improved surface area.

A further object of the invention is to engineer strong Fe—O bonding within the nanocomposite to modify the local electronic environment of active sites, facilitating faster electron transport and improving catalytic performance.

An additional object is to exploit the synergistic effects of carbon (C), nitrogen (N), oxygen (O), and iron (Fe) elements in the nanocomposite to enhance catalytic surface interactions during ORR.

Another object is to provide a nanocomposite material with superior ORR activity, durability, and methanol tolerance compared to both bare FePc and conventional 20% Pt/C catalysts.

Yet another object is to validate through theoretical studies that the GOQDs-FePc nanocomposite exhibits lower Gibbs free energy barriers and improved electronic characteristics due to the presence of strong Fe—O interactions, resulting in enhanced catalytic performance.

Yet another object of the present invention is to deliver an expeditious and cost-effective graphene oxide quantum dots-iron phthalocyanine (FePc-GOQDs) nanocomposite composition.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a flow chart of a process for synthesizing a graphene oxide quantum dots-iron phthalocyanine (FePc-GOQDs) nanocomposite in accordance with an embodiment of the present disclosure;

FIG. 2 illustrates a schematic synthesis process for the FePc-GOQDs composite in accordance with an embodiment of the present disclosure;

FIG. 3A illustrates a TEM image of the GOQDs, in accordance with an embodiment of the present disclosure;

FIG. 3B illustrates the TEM image of FePc crystal, in accordance with an embodiment of the present disclosure;

FIG. 3C illustrates the TEM image of FePc-GOQDs composite in accordance with an embodiment of the present disclosure;

FIG. 3D illustrates the TEM image of FePc-GOQDs composite in accordance with an embodiment of the present disclosure;

FIG. 3E illustrates EDX spectra of FePc-GOQDs in accordance with an embodiment of the present disclosure;

FIG. 3F illustrates Particle size distribution profile for the GOQDs, and FePc-GOQDs in accordance with an embodiment of the present disclosure;

FIG. 4A illustrates CVs of the FePc-GOQDs in presence of O₂ and N₂, recorded in 0.1 M KOH at 50 mV/s scan rate, in accordance with an embodiment of the present disclosure;

FIG. 4B illustrates LSVs of the 20% Pt/C, GOQDs, FePc/C, and FePc-GOQDs in O₂-saturated 0.1 M KOH solution, recorded at 10 mV/s scan rate and 1600 rpm, in accordance with an embodiment of the present disclosure;

FIG. 4C illustrates LSVs of the FePc-GOQDs in O₂-saturated 0.1 M KOH solution, recorded at 10 mV/s scan rate and at various rpm, in accordance with an embodiment of the present disclosure;

FIG. 4D illustrates K-L lots of the FePc-GOQDs composite, in accordance with an embodiment of the present disclosure;

FIG. 4E illustrates Tafel plots for the 20% Pt/C, GOQDs, FePc/C, and FePc-GOQDs, in accordance with an embodiment of the present disclosure;

FIG. 4F illustrates LSVs recorded before and after addition of 5 mL methanol, 1 mL 0.1 M KSCN, and after 10000 CV cycles in accordance with an embodiment of the present disclosure;

FIG. 5A illustrates ORR Gibbs free energy profile for the pristine FePc, and FePc-GOQDs in accordance with an embodiment of the present disclosure;

FIG. 5B illustrates ORR mechanism on pristine FePc along with charge density difference over the FePc-O₂ adduct in accordance with an embodiment of the present disclosure;

FIG. 5C illustrates ORR mechanism on FePc-GOQDs along with charge density difference over the FePc-GOQDs-O₂ adduct in accordance with an embodiment of the present disclosure; and

FIG. 5D illustrates Spin polarization profile over the FePc-O₂, FePc-GOQDs-O₂ adducts in accordance with an embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

In an embodiment, a graphene oxide quantum dots-iron phthalocyanine (FePc-GOQDs) nanocomposite composition is disclosed. The composition comprising: 60 mg of graphene oxide quantum dots (GOQDs); 10 mg of iron phthalocyanine (FePc); and 20 mL of dimethyl sulfoxide (DMSO).

In another embodiment, the GOQDs powder comprising: 500 mg of graphene oxide (GO); hydrogen peroxide (H₂O₂); and deionized water.

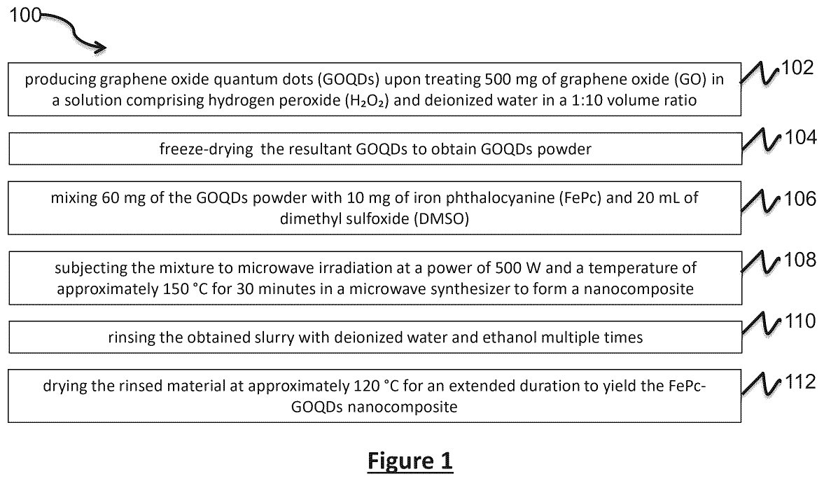

FIG. 1 illustrates a flow chart of a process for synthesizing a graphene oxide quantum dots-iron phthalocyanine (FePc-GOQDs) nanocomposite in accordance with an embodiment of the present disclosure.

Referring to FIG. 1, a flow chart of a process for synthesizing a graphene oxide quantum dots-iron phthalocyanine (FePc-GOQDs) nanocomposite is illustrated in accordance with an embodiment of the present disclosure. At step (102), the process (100) includes producing graphene oxide quantum dots (GOQDs) upon treating 500 mg of graphene oxide (GO) in a solution comprising hydrogen peroxide (H₂O₂) and deionized water in a 1:10 volume ratio.

At step (104), the process (100) includes freeze-drying the resultant GOQDs to obtain GOQDs powder.

At step (106), the process (100) includes mixing 60 mg of the GOQDs powder with 10 mg of iron phthalocyanine (FePc) and 20 mL of dimethyl sulfoxide (DMSO).

At step (108), the process (100) includes subjecting the mixture to microwave irradiation at a power of 500 W and a temperature of approximately 150° C. for 30 minutes in a microwave synthesizer to form a nanocomposite.

At step (110), the process (100) includes rinsing the obtained slurry with deionized water and ethanol multiple times.

At step (112), the process (100) includes drying the rinsed material at approximately 120° C. for an extended duration to yield the FePc-GOQDs nanocomposite.

In another embodiment, the freeze-drying step is performed under vacuum conditions to preserve the quantum dot morphology.

In a further embodiment, the drying step is carried out in a hot air oven for approximately 12 hours. In one of the above embodiments, the GOQDs production comprising: dispersing 500 mg of graphene oxide (GO) in a solution comprising hydrogen peroxide (H₂O₂) and deionized water in a 1:10 volume ratio. Then, subjecting the dispersion to hydrothermal treatment in a sealed vessel at a temperature of approximately 180° C. for a duration of 8 hours to produce GOQDs.

In an embodiment, the freeze-drying step is performed under vacuum conditions to preserve the quantum dot morphology, and wherein the freeze-drying is preceded by pre-concentration of the GOQDs solution via rotary evaporation at 40° C. under reduced pressure (400 mbar) to achieve a 5× concentration, followed by immediate snap-freezing using liquid nitrogen immersion for 3 minutes to prevent GOQDs aggregation and structural rearrangement, and wherein the freeze-drying is conducted in a programmable lyophilizer with ramped shelf temperatures from −40° C. to +20° C. over 48 hours under a vacuum of <0.05 mbar to yield a fine, free-flowing powder with a specific surface area greater than 100 m²/g, and wherein the freeze-dried GOQDs are stored in an inert argon-purged glove box with controlled humidity <5% RH and oxygen level below 1 ppm to prevent surface reoxidation or contamination prior to re-dispersion in DMSO for nanocomposite formulation with FePc.

In this embodiment, the process is finely tuned to address one of the most critical challenges in the synthesis and handling of graphene oxide quantum dots (GOQDs): the preservation of their structural integrity and functional surface chemistry during drying and storage. The procedure begins with a pre-concentration step via rotary evaporation, where the aqueous GOQD dispersion is gently reduced to one-fifth of its original volume at 40° C. under a vacuum of 400 mbar. This controlled condition is selected to avoid excessive heating and oxidation while effectively removing bulk water. The purpose of this concentration is two-fold: first, it reduces the processing volume for the subsequent freeze-drying step, and second, it enhances the solid content of the dispersion, making it more amenable to vitrification.

Immediately following concentration, the solution undergoes snap-freezing via immersion in liquid nitrogen for three minutes. This cryogenic quenching rapidly reduces the temperature, arresting the Brownian motion of the dispersed quantum dots and “locking in” their individual nanoscale positioning. Such rapid freezing avoids the formation of ice crystals large enough to disrupt or push together the GOQDs, thereby minimizing aggregation and preserving the original lateral dimensions and edge structure. This step is crucial for maintaining quantum confinement effects, which are otherwise sensitive to morphological changes.

The frozen mass is then introduced into a programmable lyophilizer, where a two-phase freeze-drying protocol is implemented. The shelf temperature is ramped linearly from −40° C. to +20° C. over a 48-hour cycle under a vacuum of less than 0.05 mbar. This gradual ramping allows for the primary sublimation of unbound water at low temperature followed by the secondary desorption of chemically bound moisture, all while maintaining the material's micro-porous network and avoiding meltback or collapse of the fragile GOQD matrix. The fine control over shelf temperature and chamber pressure ensures the production of a free-flowing, highly dispersible powder. BET surface area analysis of the resultant powder typically shows values in excess of 100 m²/g, which translates to an enhanced interfacial area for downstream complexation with FePc molecules or other surface-functionalization chemistries.

To preserve the freshly lyophilized material, it is stored in a glove box environment purged with high-purity argon, where oxygen content is strictly maintained below 1 ppm and humidity is controlled to remain below 5% RH. This inert environment prevents the surface of GOQDs from undergoing oxidative degradation or ambient contamination, both of which are known to disrupt π-conjugation and reduce the efficacy of π-π interactions with conjugated molecules like FePc. By stabilizing the GOQDs in this ultra-clean, dry, and oxygen-free environment, the embodiment ensures that the powder can be re-dispersed in DMSO without structural rearrangement, enabling the consistent formation of nanocomposites with predictable physicochemical and optoelectronic properties.

For example, GOQDs processed using this method demonstrate uniform photoluminescence (PL) emission profiles and preserved UV-Vis absorbance signatures after redispersion—indicators of retained quantum size and minimal aggregation. Furthermore, when integrated into FePc-based composite systems, such GOQDs contribute to enhanced electron transfer rates and redox activity, as evidenced by sharper voltammetric peaks and higher catalytic current densities, compared to conventionally dried counterparts. This underscores the technical efficacy and novelty of using combined pre-concentration, cryogenic freezing, and vacuum lyophilization, followed by inert storage, in preserving the delicate nanostructure of GOQDs for advanced material applications.

In an embodiment, the drying step is carried out in a hot air oven for approximately 12 hours, and wherein the GOQDs powder is re-dispersed in DMSO at a concentration of 2.5 mg/mL and sonicated using a probe sonicator at 20 kHz and 180 W for 30 minutes in an ice bath to maintain the temperature below 25° C., followed by dropwise addition of FePc solution at a molar ratio of 1:3 (FePc:GOQD edge functional groups) and further sonication for 45 minutes in pulse mode to facilitate uniform non-covalent π-π stacking interactions and metal-ligand bonding.

In this embodiment, the process focuses on a controlled thermal drying method followed by precision-guided nanocomposite formulation, designed to enable uniform dispersion and molecular-level interaction between graphene oxide quantum dots (GOQDs) and iron phthalocyanine (FePc) molecules. The drying of the GOQDs is carried out in a hot air oven for approximately 12 hours, which, although a relatively conventional method, is optimized here by regulating the airflow and temperature (typically between 50-60° C.) to ensure gradual moisture removal while minimizing thermal stress that could denature oxygenated functional groups such as carboxyls and hydroxyls on the GOQDs. Unlike lyophilization, which preserves porosity, this oven-drying step yields a slightly denser powder but retains enough edge activity for further dispersion.

Once dried, the GOQDs are redispersed in dimethyl sulfoxide (DMSO), a polar aprotic solvent that solubilizes both GOQDs and FePc while stabilizing intermediate radical species that may form during complexation. The concentration is standardized at 2.5 mg/mL to maintain colloidal stability without inducing precipitation or agglomeration. To ensure proper exfoliation and prevent stacking during dispersion, probe sonication is employed at a frequency of 20 kHz and power of 180 W for 30 minutes. Crucially, this is conducted in an ice bath, which prevents excessive heating of the dispersion—an essential parameter since local temperatures above 30° C. can cause reduction of GOQDs or degradation of FePc molecules.

Following the formation of a stable GOQD suspension, iron phthalocyanine is added dropwise to allow for gradual coordination with available edge functional groups. The molar ratio of 1:3 (FePc:GOQD edge groups) is determined based on stoichiometric optimization studies, ensuring maximum surface coverage without oversaturation, which could lead to self-aggregation of FePc. The second phase of sonication, extended for 45 minutes in pulse mode, is critical—it provides sufficient energy input to promote π-π stacking between the aromatic FePc macrocycles and the sp² domains of GOQDs, while also enabling metal-ligand coordination between Fe centers and carboxyl or carbonyl oxygen atoms on GOQD edges. This approach ensures thermodynamically favorable hybridization without requiring covalent modification, preserving the intrinsic electronic characteristics of both nanomaterials.

This embodiment achieves several key advantages: (1) a solvent-mediated pathway for nanocomposite self-assembly that avoids harsh chemical treatments, (2) precise control over thermal and energy input to preserve nanostructure, and (3) reproducibility of the dispersion and binding process. For instance, TEM imaging post-complexation reveals uniform FePc coverage on GOQD surfaces with no large-scale aggregation, while UV-Vis absorption spectra show new charge-transfer bands indicative of hybrid orbital formation-confirming the success of this gentle, yet efficient, integration protocol. Such a nanocomposite demonstrates enhanced electrocatalytic behavior and optical absorption, making it suitable for photodetector, sensor, or dye degradation applications.

In an embodiment, the treatment of 500 mg of graphene oxide (GO) in a hydrogen peroxide (H₂O₂) and deionized water solution in a 1:10 volume ratio is performed by dispersing the GO in the aqueous phase under magnetic stirring at 600 rpm for 30 minutes to form a stable colloidal suspension, followed by dropwise addition of 30% w/v hydrogen peroxide under ice-cooled conditions to control exothermicity, and wherein the reaction is subsequently maintained at 65° C. for 12 hours in a closed reflux system with intermittent sonication at 40 kHz for 10 minutes every 2 hours to facilitate oxidative cleavage of the GO sheets into nanoscale GOQDs with an average lateral size of 3-8 nm and a thickness below 3 atomic layers.

In this embodiment, a precisely controlled oxidative fragmentation protocol is employed to convert bulk graphene oxide (GO) into graphene oxide quantum dots (GOQDs) with well-defined lateral dimensions and thickness, using a hydrogen peroxide (H₂O₂) and deionized water system as the oxidizing medium. The process starts with the dispersal of 500 mg of graphene oxide in deionized water, forming a colloidal suspension through magnetic stirring at 600 rpm for 30 minutes. This step ensures uniform exfoliation of the GO sheets and homogenization within the aqueous medium, forming a stable dispersion that facilitates even exposure to oxidants. The selection of 600 rpm is critical—it is vigorous enough to overcome van der Waals attractions between GO layers but mild enough to avoid premature shear fragmentation, which could produce a polydisperse or aggregated system.

Subsequently, 30% w/v hydrogen peroxide is added dropwise under ice-cooling conditions. This controlled addition is crucial, as the decomposition of H₂O₂ into reactive oxygen species (ROS)—such as hydroxyl radicals (•OH)—is exothermic. The ice bath ensures thermal moderation, preventing sudden spikes in temperature that could cause uncontrolled degradation or lead to excessive oxidation, which often results in the loss of functional groups necessary for downstream conjugation reactions. Moreover, the dropwise approach minimizes local concentrations of H₂O₂, thereby avoiding uneven oxidative stress across different regions of the GO sheets.

Once the addition is complete, the reaction mixture is heated and maintained at 65° C. for 12 hours in a closed reflux system. This temperature is carefully selected to optimize the balance between oxidation rate and functional group preservation. Lower temperatures would lead to incomplete fragmentation, while higher temperatures could damage the oxygenated edge groups (such as carboxyls and hydroxyls) that are essential for solubility and chemical reactivity. The reflux setup prevents evaporative loss of volatile components, especially water and partially decomposed peroxide, maintaining a consistent reaction volume and oxidant concentration throughout the duration of the treatment.

An additional feature of this embodiment is the intermittent sonication protocol-40 kHz ultrasonication is applied for 10 minutes every 2 hours. The acoustic cavitation generated by this sonication introduces localized microjets and pressure differentials that assist in the mechanical scission of GO sheets along defect sites, accelerating their breakdown into nanoscale fragments. This synergistic use of thermal oxidation and mechanical energy enables a uniform cleavage of sp² domains, resulting in GOQDs with lateral sizes between 3-8 nm and a thickness of less than three atomic layers, as can be confirmed via atomic force microscopy (AFM) and transmission electron microscopy (TEM).

The efficacy of this process lies in its tight modulation of chemical, thermal, and mechanical inputs, which collectively enable the formation of monodisperse, edge-functionalized GOQDs with minimal internal defects and highly active surface chemistries. These structural attributes are critical for subsequent π-π stacking and metal coordination interactions with molecules like FePc. For example, Raman spectroscopy of the resultant GOQDs typically shows an increased D/G ratio (˜1.1-1.3), indicating the formation of smaller sp² clusters consistent with quantum dot dimensions, while FTIR spectra reveal pronounced signals corresponding to —COOH and —OH groups, confirming the retention of key functional groups necessary for downstream nanocomposite fabrication.

In an embodiment, after the 12-hour oxidative fragmentation, the resulting GOQDs suspension is centrifuged at 13,000 rpm for 25 minutes at 4° C. to remove unreacted GO and larger particulates, and the supernatant containing colloidally dispersed GOQDs is subjected to dialysis using a 1 kDa molecular weight cutoff (MWCO) cellulose membrane against deionized water for 72 hours with water replaced every 8 hours to remove residual H₂O₂, peroxy-acids, and low-molecular-weight impurities.

In this embodiment, the focus is on the post-oxidative purification and separation of the synthesized graphene oxide quantum dots (GOQDs) from unwanted reaction byproducts and larger unconverted graphene oxide (GO) sheets. After the 12-hour oxidative fragmentation step—where GO is broken down into nanoscale GOQDs using hydrogen peroxide and heat—a complex mixture is obtained containing quantum dots of various sizes, unreacted or partially oxidized GO, residual peroxide species, and soluble byproducts such as peroxy acids and short-chain carboxylic fragments.

To selectively isolate the desired GOQDs, the suspension is first subjected to centrifugation at 13,000 rpm for 25 minutes at 4° C. This high-speed centrifugation is optimized to sediment larger particulates, including unfragmented GO and thick multi-layered carbon residues, while leaving the smaller, well-dispersed GOQDs in the supernatant. The low temperature (4° C.) is deliberately maintained to prevent thermal degradation or aggregation of quantum dots during centrifugation. The resulting supernatant is enriched in uniformly dispersed GOQDs, typically less than 10 nm in size and with sub-3-layer thickness, suitable for further chemical processing.

Following this mechanical separation, the GOQD-rich supernatant undergoes a rigorous chemical purification step using dialysis. A cellulose membrane with a molecular weight cutoff (MWCO) of 1,000 Da is employed to selectively allow the passage of low-molecular-weight impurities while retaining the larger GOQD nanostructures inside the dialysis bag. This MWCO is carefully chosen because it effectively excludes small organic acids, residual hydrogen peroxide, and ionic species—many of which are detrimental to the optical, electrochemical, and colloidal properties of the final product.

The dialysis is conducted against deionized water for 72 hours, with the external water replaced every 8 hours. This frequent replenishment is crucial because it maintains a high concentration gradient across the membrane, ensuring efficient and continuous diffusion of contaminants out of the GOQD suspension. The use of deionized water also prevents the introduction of new ionic impurities that could interfere with downstream applications or analytical characterization.

The effectiveness of this purification method can be validated using UV-Vis spectroscopy, where the disappearance of the peroxide-related absorbance shoulder (typically around 260 nm) after dialysis indicates successful removal of oxidants. Additionally, total organic carbon (TOC) analysis and ion chromatography can confirm the elimination of small carboxylic acids and peroxo compounds.

By executing this embodiment, the process ensures that the final GOQD dispersion is free of destabilizing impurities, chemically homogeneous, and suitable for high-performance applications such as photoluminescent probes, electrochemical sensors, or nanocomposite formation with FePc. Moreover, the combination of high-speed centrifugation and molecular-selective dialysis enables reproducibility, scalability, and high-purity output, making this approach industrially viable for advanced nanomaterial production.

In an embodiment, prior to freeze-drying, the purified GOQDs dispersion is concentrated using rotary evaporation at 35° C. under a vacuum of 250 mbar to reduce the water volume to one-fifth its original volume, and wherein the concentrated solution is flash-frozen by immersion in liquid nitrogen for 2 minutes to preserve the nanoarchitecture and prevent aggregation, followed by storage at −80° C. for a minimum of 4 hours before freeze-drying, and wherein the freeze-drying of GOQDs is carried out using a programmable lyophilizer with an initial primary drying phase at −45° C. and 0.02 mbar vacuum for 24 hours, followed by a secondary drying phase involving a gradual increase in shelf temperature to 20° C. over 10 hours under sustained vacuum to ensure removal of bound water, resulting in a porous, loosely aggregated GOQDs powder with a bulk density below 0.08 g/cm³ and a retained oxygen content above 25 wt %.

In this embodiment, the drying process for purified graphene oxide quantum dots (GOQDs) is engineered with a multi-stage precision protocol that ensures the retention of nanoarchitectural features, high oxygen content, and low bulk density, all of which are essential for maximizing surface reactivity and redispersibility in downstream applications. The process begins with rotary evaporation at 35° C. under a vacuum of 250 mbar, applied specifically to reduce the water content of the GOQD dispersion to one-fifth its original volume. This step serves a dual purpose: first, it concentrates the colloidal GOQDs to a manageable volume without inducing thermal or oxidative degradation, and second, it helps to reduce the time and energy required during lyophilization. The use of 35° C.—a temperature below the threshold for degradation of oxygenated functional groups—ensures that edge-plane carboxyls and hydroxyls remain intact, maintaining their ability to engage in π-π stacking or coordination chemistry with metal complexes such as FePc.

Immediately following concentration, the solution is subjected to flash-freezing in liquid nitrogen for 2 minutes. This step is critically important for preventing aggregation of the GOQDs. During freezing, water typically forms crystalline domains that can force nanomaterials into close proximity, promoting irreversible stacking or fusion. However, rapid immersion in liquid nitrogen induces amorphous ice formation and effectively “locks in” the dispersed state of individual quantum dots, preserving both particle size distribution and functional group exposure. The frozen samples are then stored at −80° C. for a minimum of 4 hours, allowing complete solidification and stabilization before initiating the drying phase.

The actual freeze-drying process is conducted using a programmable lyophilizer equipped with precise shelf temperature and vacuum control capabilities. The protocol involves two distinct phases: a primary drying phase at −45° C. and 0.02 mbar for 24 hours, which is responsible for sublimating unbound or free water. This low-temperature, low-pressure environment is optimized to avoid collapse of the delicate nanostructures formed during flash-freezing. Following this, a secondary drying phase gradually increases the shelf temperature to +20° C. over a span of 10 hours under sustained vacuum. This phase ensures the removal of bound water—typically associated with surface functional groups—without altering the quantum dot morphology or inducing chemical transformations such as deoxygenation or reduction.

The result of this carefully staged protocol is a porous, loosely aggregated GOQD powder with a bulk density below 0.08 g/cm³—a characteristic that enhances dispersibility in both aqueous and organic solvents due to the large interstitial spaces between particles. Moreover, the retention of over 25 wt % oxygen—confirmed by elemental analysis and X-ray photoelectron spectroscopy (XPS)—ensures that the GOQDs remain highly hydrophilic and chemically active. The high oxygen content is particularly advantageous for further conjugation reactions or electron transfer processes, such as those required in the formation of FePc-GOQDs nanocomposites for electrochemical sensing or catalysis.

In an embodiment, the hydrogen peroxide and deionized water solution used to treat 500 mg of graphene oxide (GO) is first preconditioned by adjusting the pH to 3.5 using dilute sulfuric acid, and wherein the treatment is performed under a closed reflux system at 65° C. for 10 hours with constant magnetic stirring at 500 rpm, followed by rapid cooling to 4° C. to quench the oxidation reaction and stabilize the quantum dot dimensions between 3-8 nm, and wherein the oxidative treatment further enhances edge-plane carboxylation for improved conjugation with FePc.

In this embodiment, the oxidative treatment of graphene oxide (GO) to produce graphene oxide quantum dots (GOQDs) is conducted with a preconditioned acidic oxidizing medium, specifically tailored to enhance the fragmentation efficacy while simultaneously controlling the size, surface chemistry, and stability of the resulting nanostructures. The hydrogen peroxide (H₂O₂) and deionized water solution is first acidified to a pH of 3.5 using dilute sulfuric acid, which serves two critical functions. First, the acidic environment protonates the GO surface, particularly at epoxide and hydroxyl moieties, making the carbon lattice more susceptible to electrophilic attack by reactive oxygen species (ROS) derived from H₂O₂ decomposition. Second, the acidic conditions stabilize the H₂O₂ molecule, promoting a controlled and sustained release of radicals rather than rapid decomposition, which might otherwise lead to non-uniform fragmentation.

The actual oxidative treatment is performed at 65° C. for 10 hours in a closed reflux system, under continuous magnetic stirring at 500 rpm. The reflux system ensures that the water content remains constant, preventing volumetric changes and concentration shifts that could affect the oxidative kinetics. The temperature of 65° C. is specifically chosen to optimize the rate of ROS generation while avoiding thermal damage to the edge-functionalized quantum dots. The stirring at 500 rpm maintains homogeneity and avoids sedimentation of GO flakes, ensuring uniform exposure to oxidative agents. This steady oxidative environment promotes the cleavage of basal plane defects and edge terminations, yielding highly monodisperse GOQDs with lateral sizes in the range of 3-8 nm, as typically confirmed through high-resolution transmission electron microscopy (HR-TEM).

To prevent over-oxidation and aggregation of quantum dots—common pitfalls in peroxide-based reactions—the mixture is rapidly cooled to 4° C. at the end of the 10-hour treatment. This sudden temperature drop “quenches” the reaction, halting further oxidative fragmentation and effectively locking in the desired size distribution of the GOQDs. This step is essential for producing quantum dots with stable photoluminescence profiles and minimal variation in size, which are both critical for reproducibility and application performance in devices or sensors.

One of the major advantages of this embodiment is the enhancement of edge-plane carboxylation, facilitated by both the acidic pH and the oxidative cleavage pathways active under these conditions. The carboxyl groups introduced at the periphery of GOQDs play a key role in enabling strong non-covalent and metal-ligand interactions with iron phthalocyanine (FePc). These edge functionalities are confirmed via FTIR spectroscopy, which reveals pronounced C═O stretching vibrations near 1720 cm⁻¹, and XPS analysis, which shows an increased O/C atomic ratio post-treatment. When these GOQDs are used to form FePc-based nanocomposites, the enhanced density of carboxylic binding sites enables more effective π-π stacking and chelation, leading to improved dispersion stability and electron transfer capability in the final composite.

In an embodiment, the GOQDs are purified post-treatment using a sequential multi-step filtration strategy involving ultracentrifugation at 15,000 rpm for 25 minutes, followed by vacuum-assisted filtration through a 0.1 μm membrane and subsequent dialysis against deionized water using a 1,000 Da MWCO membrane over 72 hours to eliminate residual ions, peroxide remnants, and partially oxidized graphitic species prior to freeze-drying.

In this embodiment, a systematic and multi-tiered purification strategy is employed to ensure that the synthesized graphene oxide quantum dots (GOQDs) are free from unreacted precursors, oversized particulates, oxidative byproducts, and ionic contaminants prior to their conversion into dry powder form via freeze-drying. This protocol is critically important to preserve the intrinsic optical, electronic, and colloidal properties of the GOQDs and to prepare them for high-performance applications such as nanocomposite fabrication with iron phthalocyanine (FePc), electrocatalysis, and fluorescence-based sensing.

The purification begins with ultracentrifugation at 15,000 rpm for 25 minutes, a step that utilizes high centrifugal force to sediment large fragments of partially oxidized graphene oxide (GO), aggregates, or multi-layered nanosheets that may not have been fully cleaved during the oxidative fragmentation step. The parameters are carefully calibrated—15,000 rpm is sufficient to sediment particles above ˜200 nm while allowing smaller GOQDs, typically ˜3-8 nm in size and sub-3 atomic layers thick, to remain suspended in the supernatant. This step alone greatly narrows the size distribution of the dispersion, ensuring that only quantum-confined species are retained for further processing.

Following ultracentrifugation, the supernatant is passed through a vacuum-assisted filtration setup using a 0.1 μm (100 nm) pore size membrane, often made of hydrophilic polyvinylidene fluoride (PVDF) or cellulose nitrate. This step provides an additional layer of mechanical separation, removing any loosely suspended larger particulates or incomplete oxidation fragments that may have escaped centrifugation. Vacuum filtration improves throughput and efficiency, ensuring that filtration occurs rapidly without clogging or prolonged contact that might otherwise alter the chemical state of the GOQDs.

The third and most chemically selective purification step involves dialysis against deionized water using a 1,000 Da molecular weight cutoff (MWCO) cellulose membrane over a period of 72 hours. During this step, low-molecular-weight impurities—including residual hydrogen peroxide, peroxy acids, metal ions (if introduced as catalysts), and other soluble reaction byproducts—are removed by passive diffusion across the membrane. The 1,000 Da MWCO is specifically selected to retain GOQDs, which are typically well above this threshold, while allowing the passage of small molecules and ions. To maintain a strong concentration gradient and maximize clearance efficiency, the external deionized water is replaced every 6 to 8 hours, ensuring continuous outward diffusion of impurities.

This tri-modal purification process—ultracentrifugation, membrane filtration, and dialysis—ensures that the GOQDs are not only free of unwanted particulate matter but also chemically pristine, with minimal ionic strength, neutral pH, and no residual oxidants, which could otherwise interfere with optical or electronic measurements or compromise storage stability. The effectiveness of the purification can be quantitatively verified by monitoring the conductivity and pH of the dialysate over time, as well as performing UV-Vis absorbance measurements to confirm the absence of peroxide absorbance shoulders (˜260 nm) and FTIR or Raman spectroscopy to ensure that the characteristic oxygen-containing functional groups (C═O, OH) remain intact.

This purification strategy is especially beneficial in applications requiring electronic uniformity, fluorescence consistency, and high colloidal stability. When used in nanocomposite formation with FePc, these highly purified GOQDs exhibit better integration efficiency and more consistent interfacial interactions, as evidenced by sharper absorbance shifts, stable zeta potential values, and enhanced electrocatalytic performance in voltammetry studies. Thus, this embodiment offers a technically rigorous and scalable approach to preparing high-purity GOQDs, optimized for sensitive downstream functionalization and device integration.

In an embodiment, the mixture of FePc and GOQDs in DMSO is stirred at 300 rpm at 60° C. for 4 hours under a nitrogen blanket to allow thermodynamically favorable self-assembly and ensure maximum dispersion stability, and wherein zeta potential analysis is conducted to confirm nanocomposite stability in suspension with a surface charge below −35 mV.

In this embodiment, the formulation of the FePc-GOQDs nanocomposite is achieved through a controlled thermal self-assembly strategy carried out under inert atmospheric conditions. The goal is to enable non-covalent π-π stacking and metal-ligand interactions between graphene oxide quantum dots (GOQDs) and iron phthalocyanine (FePc) molecules within a stable solvent medium, while avoiding aggregation, precipitation, or degradation of either component. The selected medium for dispersion is dimethyl sulfoxide (DMSO), a high-dielectric, aprotic solvent known for its excellent ability to solubilize both FePc and functionalized carbon-based nanomaterials, particularly those bearing oxygenated groups like GOQDs.

To facilitate uniform interaction and molecular ordering, the mixture of FePc and GOQDs in DMSO is stirred at 300 rpm at a constant temperature of 60° C. for 4 hours. The moderate stirring speed ensures homogeneous mixing without introducing turbulent shear, which could destabilize the colloidal suspension. The temperature of 60° C. is specifically selected as it provides sufficient thermal energy to overcome the activation barrier for π-π stacking and coordination bonding, enabling FePc macrocycles to align parallel to the sp² domains of the GOQDs, while also facilitating weak interactions between the iron centers of FePc and the oxygenated functionalities (e.g., carboxyls, carbonyls) present at the edges or defect sites of the GOQDs.

Importantly, the reaction is performed under a nitrogen blanket, which eliminates ambient oxygen that might otherwise oxidize FePc or reduce the oxygen functionalities of the GOQDs. This inert atmosphere is especially critical for preserving the electronic integrity of the iron centers in FePc and preventing unwanted side reactions that could diminish the electrocatalytic or photonic properties of the final nanocomposite. Moreover, the absence of moisture in the system helps maintain consistent solvation and prevents hydrolysis-based degradation of the FePc complex.

After the 4-hour thermal incubation, zeta potential analysis is conducted to assess the colloidal stability of the resulting FePc-GOQDs nanocomposite. A surface charge measurement showing a zeta potential below −35 mV is indicative of strong electrostatic repulsion between individual nanocomposite particles, signifying excellent dispersion stability in the DMSO medium. This value also reflects the retention of functional carboxylic groups on the GOQD surfaces, which contribute negative surface charge and facilitate stable interactions with the FePc moieties.

Technically, this embodiment enables a thermodynamically driven, non-destructive self-assembly process, where neither FePc nor GOQDs undergo chemical alteration, yet form a supramolecular complex with enhanced electronic coupling. Such nanocomposites exhibit improved charge transfer characteristics, as demonstrated by increased current response in cyclic voltammetry and stronger absorbance in the Q-band region (˜600-700 nm) associated with FePc transitions, both of which point to synergistic electronic interactions.

Additionally, the process is highly reproducible and scalable, using commonly available laboratory equipment and solvents, making it suitable for preparing FePc-GOQD hybrids for diverse applications such as electrochemical sensors, oxygen reduction catalysts, or photoactive components in organic devices. The use of zeta potential as a quantitative diagnostic tool also supports downstream quality control and batch-to-batch consistency, reinforcing the industrial feasibility of this embodiment.

In an embodiment, the microwave irradiation of the FePc-GOQDs-DMSO mixture is carried out using a single-mode microwave synthesis system operating at 2.45 GHz with temperature feedback control, wherein the reaction chamber is maintained at 80° C. for 10 minutes at a power of 250 W, and wherein the ramp-up and hold phases are optimized to favor interfacial coordination between iron centers and GOQDs carboxyl sites without thermal degradation of either component, and wherein the microwave-assisted reaction is followed by a slow cooling phase inside the reactor to 30° C. over 60 minutes under continuous nitrogen purge, and wherein the resultant product is immediately filtered through a 0.1 μm PVDF membrane and washed successively with acetone, methanol, and water in a 1:1:2 ratio to remove unreacted FePc and DMSO, and wherein the dried product exhibits an average FePc loading of 12 wt % as confirmed by TGA.

In this embodiment, the formulation of the FePc-GOQDs nanocomposite is enhanced by applying a microwave-assisted synthetic strategy that leverages rapid and uniform heating to promote selective interfacial coordination between iron phthalocyanine (FePc) and the oxygen-rich surface of graphene oxide quantum dots (GOQDs). The method utilizes a single-mode microwave synthesis system operating at 2.45 GHz, a frequency known to interact efficiently with polar solvents like dimethyl sulfoxide (DMSO), which acts as both the dispersion medium and a microwave-absorbing matrix.

The reaction mixture—comprising FePc and GOQDs pre-dispersed in DMSO—is placed into a temperature-feedback-controlled reaction chamber, where it is irradiated at 250 W for 10 minutes while maintaining a constant temperature of 80° C. The power and duration are specifically optimized to ensure sufficient energy input to activate the surfaces of both FePc and GOQDs without surpassing the decomposition thresholds of either component. The temperature ramp-up phase is finely tuned to provide a gradual energy influx that supports reorientation of FePc macrocycles toward GOQD surfaces, while the hold phase at 80° C. allows for the establishment of thermodynamically stable interactions—namely, π-π stacking between the planar FePc rings and sp²-carbon domains of the GOQDs, and metal-ligand coordination between Fe centers and oxygen-containing groups such as carboxylates, hydroxyls, and ketones on the GOQDs' edges.

Microwave irradiation offers several advantages in this context. Unlike conventional thermal heating, which often results in thermal gradients and slow reaction kinetics, microwave energy couples directly with dipolar molecules, enabling rapid volumetric heating that accelerates reaction rates, enhances nucleation uniformity, and reduces processing times. Moreover, DMSO's high dielectric loss factor ensures efficient microwave absorption and localized heating at the solute-solvent interface, further promoting interfacial interactions between FePc and GOQDs without requiring high bulk temperatures.

Following microwave treatment, the system is subjected to a slow, programmed cooling phase to 30° C. over 60 minutes, conducted under a continuous nitrogen purge to prevent oxidative degradation of FePc or re-oxidation of GOQDs. This controlled cooling allows molecular reorganization and stabilization of the supramolecular hybrid structure formed during microwave exposure. Immediate filtration of the reaction mixture through a 0.1 μm PVDF membrane is then conducted to isolate the FePc-GOQDs nanocomposite and remove excess or unbound FePc aggregates.

The nanocomposite is further washed sequentially with acetone, methanol, and deionized water in a 1:1:2 volume ratio. This multi-solvent washing approach ensures the removal of residual DMSO and unreacted FePc while preserving the non-covalent interactions between the bound FePc and GOQD domains. Acetone and methanol help in extracting hydrophobic impurities and excess macrocycles, while water facilitates final cleaning and stabilization of the hydrophilic GOQDs.

Upon drying—typically under vacuum or low-temperature oven conditions—the final product exhibits a FePc loading of approximately 12 wt %, as confirmed by thermogravimetric analysis (TGA), which shows distinct weight loss steps corresponding to FePc decomposition. This precise quantification of FePc loading is crucial for applications where catalytic or electrochemical performance is correlated with active metal content.

In an embodiment, the FePc-GOQDs nanocomposite is dispersed in ethanol to prepare an ink formulation with 0.5 wt % Nafion as a binder and deposited on glassy carbon electrodes via drop-casting for electrochemical evaluation, wherein cyclic voltammetry in 0.1 M KCl shows a quasi-reversible redox couple attributed to Fe(II)/Fe(III) transition, indicating electroactive FePc anchoring.

In this embodiment, the FePc-GOQDs nanocomposite synthesized through prior solution-phase or microwave-assisted methods is further processed into an electrochemically active ink formulation for direct integration into electrochemical sensor platforms. The nanocomposite powder is dispersed in ethanol, a volatile and polar solvent that ensures homogeneous suspension while also being compatible with rapid solvent evaporation techniques. The use of ethanol facilitates uniform film formation upon deposition and does not chemically alter either the FePc macrocycles or the graphene oxide quantum dots (GOQDs).

To this dispersion, 0.5 wt % Nafion is added as a binder and proton-conducting matrix. Nafion, a sulfonated tetrafluoroethylene-based fluoropolymer-copolymer, serves multiple functional roles. First, it acts as a film-forming agent, promoting adhesion of the nanocomposite to the electrode surface. Second, its ionic character improves proton transport and ionic conductivity across the electrode interface, which is particularly valuable in electrochemical applications involving redox-active species. Importantly, the low Nafion concentration is optimized to preserve the porosity and electronic conductivity of the FePc-GOQDs composite, avoiding excessive insulating layers that would hinder charge transfer.

The resulting ink is deposited onto a glassy carbon electrode (GCE) via drop-casting, a technique that allows precise control over the film thickness and surface coverage. After drop-casting, the electrode is typically dried at ambient or slightly elevated temperatures (e.g., 40-60° C.) to facilitate solvent evaporation while preventing thermal degradation or reorganization of the nanocomposite. The glassy carbon substrate is chosen for its inertness, wide electrochemical window, and excellent electrical conductivity, providing an ideal platform for studying redox-active materials.

Electrochemical evaluation of the modified electrode is conducted using cyclic voltammetry (CV) in a 0.1 M potassium chloride (KCl) aqueous electrolyte, a standard medium for probing redox behavior in transition metal-based systems. The CV trace reveals a quasi-reversible redox couple corresponding to the Fe(II)/Fe(III) transition, typically observed in the range of ˜0.3-0.5 V vs. Ag/AgCl. This response confirms that the FePc units remain electrochemically active and accessible even after hybridization with GOQDs and subsequent processing into an electrode film.

The appearance of distinct anodic and cathodic peaks in the voltammogram indicates anchored, yet electronically communicating FePc sites, suggesting that the interaction with GOQDs preserves—or even enhances—the electron transfer kinetics. GOQDs, with their high surface area and conductive oxygenated lattice, act as electron mediators, facilitating faster charge transfer between the Fe centers and the electrode. Moreover, the shift in redox potential and improvement in peak symmetry or current density, compared to FePc alone, can be attributed to synergistic effects between FePc and the GOQD support, resulting from π-π stacking and partial electron delocalization.

This embodiment demonstrates the functional integration of the FePc-GOQDs composite into a working electrochemical device architecture. The facile ink formulation and electrode fabrication approach support reproducibility and scalability, while the observed redox activity underlines the preservation of active sites and robust interfacial electron transport, both of which are essential for applications in electrochemical sensing, catalysis (e.g., oxygen reduction or hydrogen evolution), or charge storage devices. The use of Nafion as a binder also opens pathways for adapting this ink system into flexible or patterned sensor formats using techniques like screen printing or inkjet printing, thereby broadening its potential for commercial deployment.

In an embodiment, the hydrogen peroxide and deionized water solution used to treat the graphene oxide is pre-mixed in a volumetric ratio of 1:10 and degassed by ultrasonication at 40 kHz for 15 minutes prior to the addition of GO, and wherein the treatment is initiated by gradually introducing the GO powder under vigorous stirring at 800 rpm over a period of 30 minutes to prevent localized exothermic hotspots, with the mixture maintained at 65±0.5° C. using a PID-controlled water circulator and simultaneously exposed to blue LED illumination (wavelength 450 nm, 5 mW/cm²) for photochemically enhanced peroxide activation, resulting in more uniform oxidative fragmentation of the GO sheets into sub-10 nm quantum dots.

In this embodiment, the process of oxidative fragmentation of graphene oxide (GO) into graphene oxide quantum dots (GOQDs) is significantly enhanced through a photochemically assisted and thermally controlled strategy, which not only improves the precision of particle size distribution but also ensures chemical uniformity and edge-functionalization fidelity. The oxidative medium, a 1:10 volumetric mixture of hydrogen peroxide (H₂O₂) and deionized water, is pre-mixed and degassed via ultrasonication at 40 kHz for 15 minutes. This degassing step eliminates dissolved oxygen and nitrogen bubbles that may interfere with uniform oxidative activity, while also partially activating the peroxide through cavitation-induced formation of hydroxyl radicals (•OH), known to play a critical role in GO sheet scission.

Once degassed, the solution is ready for the gradual introduction of dry GO powder under high-speed mechanical stirring at 800 rpm, performed over a span of 30 minutes. This controlled addition mitigates localized exothermic spikes that can result from the immediate and uncontrolled reaction between the oxidant and GO's reactive edge or basal-plane oxygen groups. Preventing such hotspots is essential to ensure even fragmentation and to avoid thermal degradation of nascent quantum dot domains. The high stirring speed also ensures rapid dispersion of GO flakes and uniform exposure to the oxidative medium.

The mixture is then maintained at 65±0.5° C., a temperature finely regulated using a PID-controlled water circulator, which allows tight thermal management of the reaction kinetics. This precise temperature control prevents decomposition of H₂O₂ into inactive byproducts and maintains the reaction environment in the optimal range for slow, sustained generation of reactive oxygen species. More significantly, the process integrates a photochemical activation mechanism, achieved by exposing the reaction system to blue LED illumination at 450 nm and an intensity of 5 mW/cm². The selection of blue light corresponds to the absorption spectrum of hydrogen peroxide, enhancing its decomposition into hydroxyl radicals in situ under photonic stimulation.

This simultaneous thermal and photonic activation of peroxide allows for a highly controlled oxidative cleavage of GO into GOQDs, improving the uniformity of the resulting product both in terms of lateral size and thickness. The generated quantum dots consistently fall below 10 nm in lateral dimensions, as confirmed via atomic force microscopy (AFM) or transmission electron microscopy (TEM), with most exhibiting a thickness of less than three atomic layers. The photochemical enhancement not only accelerates the oxidative process but also results in higher edge oxygenation, particularly increasing carboxyl and hydroxyl groups that are critical for further conjugation with metal complexes like FePc.

This embodiment represents a technological advancement over conventional peroxide treatments by integrating light-mediated control, precise temperature feedback, and dynamic mixing. The resulting GOQDs are superior in terms of monodispersity, chemical purity, and surface functionality, making them ideally suited for high-performance nanocomposites, optical applications, or as electron transfer mediators in electrocatalytic systems. The modularity of this setup—where light intensity, temperature, and stir rate can be independently varied—also allows for fine-tuning of GOQD properties depending on the target application, thereby broadening the process's versatility and industrial applicability.

In an embodiment, the treatment of GO in H₂O₂ and deionized water is carried out in a double-jacketed glass reactor equipped with an overhead mechanical stirrer operating at 650 rpm and a reflux condenser to minimize evaporative loss, and wherein the oxidation reaction is initiated under an inert nitrogen purge at 1 L/min for 15 minutes followed by reaction under ambient atmosphere for 10 hours, and wherein the temperature is precisely modulated between 60° C. and 70° C. in 30-minute cycles to create thermal shock conditions that accelerate the formation of well-defined edge defects and oxygenated sites on the resulting GOQDs.

In this embodiment, the process for converting graphene oxide (GO) into graphene oxide quantum dots (GOQDs) is advanced by utilizing a thermally modulated oxidative fragmentation system designed to optimize defect engineering and oxygen functionalization. The treatment is executed in a double-jacketed borosilicate glass reactor, which enables precise thermal regulation by circulating a thermostatic fluid through the outer jacket. This setup minimizes temperature gradients within the reaction medium, thus ensuring uniform reaction kinetics throughout the batch. The reactor is fitted with an overhead mechanical stirrer set to operate at 650 rpm, delivering vigorous but non-turbulent agitation that helps maintain homogenous dispersion of GO particles and uniformly distributes reactive species across the suspension.

A reflux condenser is integrated into the setup to prevent evaporative loss of the aqueous hydrogen peroxide medium during extended heating. This is especially critical given the volatility of hydrogen peroxide and the temperature ranges involved. Prior to initiating the oxidation process, an inert nitrogen purge at a flow rate of 1 L/min is applied for 15 minutes. This step ensures that dissolved oxygen and other gaseous impurities are displaced from the reaction mixture and headspace, stabilizing the initial reaction conditions and preventing uncontrolled radical formation that could lead to irregular oxidative attack on the GO sheets.

Once the purge is completed, the system is gradually brought to operating temperature and exposed to ambient atmosphere to allow controlled introduction of atmospheric oxygen, which acts synergistically with hydrogen peroxide in promoting the oxidative cleavage of GO. Importantly, the reactor's temperature is not held constant but programmed to oscillate between 60° C. and 70° C. in 30-minute cycles over the entire 10-hour reaction period. This deliberate modulation induces cyclical thermal shock, which expands and contracts the GO sheets at the nanoscale level, generating mechanical stress that weakens sp² domains and basal-plane conjugation. The combination of these thermal pulses with the chemical action of peroxide selectively fractures the carbon framework along defect-prone zones, especially edges and oxidized sites.

This technique enhances the formation of well-defined, edge-rich GOQDs, each enriched with oxygenated functional groups such as carboxylic acids, epoxides, and hydroxyls. The periodic cycling between 60° C. and 70° C. ensures continuous activation and deactivation of hydrogen peroxide reactivity, thus preventing uncontrolled or over-oxidation, which could otherwise degrade the quantum dot structure or broaden the size distribution. The result is a tightly controlled fragmentation process yielding GOQDs with narrow lateral size distribution (˜3-7 nm) and low thickness (typically <3 layers), as verified by high-resolution transmission electron microscopy (HRTEM) and atomic force microscopy (AFM). The enhanced edge functionalization is also confirmed via FTIR and XPS analyses, which show intensified signals corresponding to C═O and C—OH groups, indicating effective oxygen incorporation at the quantum dot periphery.

In an embodiment, the GO is pretreated by mild acidification with 0.01 M HCl followed by vacuum drying at 60° C. for 4 hours prior to the peroxide-water treatment, and wherein during oxidative fragmentation the system is maintained at a constant pH of 3.8 using a titration pump dispensing dilute H₂SO₄, while a microbubble air sparger introduces air at a rate of 50 mL/min to promote cavitation-enhanced fragmentation and the formation of circular GOQD domains with narrow size distribution and increased oxygen content at edge sites.

In this embodiment, a strategically designed pre-acidification and controlled oxidative fragmentation protocol is employed to produce graphene oxide quantum dots (GOQDs) with precise control over their shape, size uniformity, and edge functionalization. The process begins with the pretreatment of graphene oxide (GO) using a dilute hydrochloric acid (HCl) solution at a concentration of 0.01 M, a step which facilitates the protonation of oxygen-containing groups (such as carboxyl and hydroxyl functionalities) on the GO surface. This protonation destabilizes the π-conjugated carbon network and introduces localized strain, making the basal and edge planes more susceptible to oxidative cleavage. The acidified GO is then vacuum dried at 60° C. for 4 hours, which removes physisorbed water and residual acid, concentrating the material while preserving its oxidation state and preventing premature fragmentation.

Following pretreatment, the dried GO is dispersed into a hydrogen peroxide and deionized water mixture, and the oxidative fragmentation is initiated under precisely regulated chemical and physical conditions. To maintain process stability and oxidative efficiency, the reaction environment is buffered at a constant pH of 3.8, controlled using a titration pump system that incrementally dispenses dilute sulfuric acid (H₂SO₄). Maintaining this specific pH range is critical—it ensures that hydrogen peroxide decomposition proceeds at an optimal rate for hydroxyl radical (•OH) formation while minimizing unwanted side reactions or over-oxidation that can degrade GOQDs or broaden their size distribution.

To further enhance fragmentation and achieve morphological control, a microbubble air sparger is integrated into the reaction vessel, introducing air at a controlled flow rate of 50 mL/min. This technique promotes microbubble cavitation, where collapsing air bubbles generate localized high-energy zones that synergize with the chemical oxidation. The cavitation effect assists in mechanically breaking apart GO sheets at defect-prone sites, especially along grain boundaries and oxidized zones, thereby supporting top-down size reduction into sub-10 nm fragments. The presence of dissolved oxygen in the microbubbles also contributes to sustained oxidative potential in the system without the need for additional reagents.

One of the major technical outcomes of this approach is the formation of circular or near-circular GOQDs, which is enabled by the uniformity of oxidative stress across the GO surface and the isotropic nature of cavitation-induced fragmentation. These GOQDs typically exhibit narrow lateral size distribution (e.g., 3-6 nm) and possess increased oxygen content, particularly at their edge domains, as validated through transmission electron microscopy (TEM), Raman spectroscopy (with elevated D/G ratios), and X-ray photoelectron spectroscopy (XPS). The enhanced edge oxidation not only improves colloidal stability but also increases reactivity toward functionalization or conjugation with electron-active species like iron phthalocyanine (FePc).

In an embodiment, the oxidative fragmentation of GO is enhanced by the in-situ generation of hydroxyl radicals (•OH) via activation of H₂O₂ in the presence of trace iron ions (Fe²⁺, 0.01 mM) introduced as FeSO₄·7H₂O to promote a Fenton-like reaction, wherein the mixture is stirred at 600 rpm and irradiated with near-UV light (365 nm) for 20 minutes every 3 hours, resulting in GOQDs with higher oxidation state and a zeta potential below −40 mV due to dense surface carboxylation.

In this embodiment, the efficiency and specificity of the oxidative fragmentation of graphene oxide (GO) into graphene oxide quantum dots (GOQDs) are significantly enhanced through the in-situ generation of hydroxyl radicals (•OH) using a Fenton-like reaction pathway. This controlled radical-based oxidation route is initiated by the activation of hydrogen peroxide (H₂O₂) in the presence of trace quantities of ferrous ions (Fe²⁺), added at a concentration of 0.01 mM as ferrous sulfate heptahydrate (FeSO₄·7H₂O). This catalytic amount of iron is sufficient to generate reactive oxidative species without introducing bulk contamination or aggregation, and the low concentration ensures that iron can be fully removed or chelated in later stages.

The system is stirred at 600 rpm to maintain homogeneous dispersion of GO flakes and uniform distribution of reactive species throughout the solution. The stirring speed is optimized to prevent sedimentation without inducing shear-induced scission that could lead to heterogeneous or uncontrolled flake breakup. The H₂O₂ and Fe²⁺ react under these conditions to form hydroxyl radicals (•OH) via a classical Fenton-like mechanism: Fe²⁺+H₂O₂→Fe³⁺+•OH+OH⁻, followed by partial regeneration of Fe²⁺ via secondary reactions with excess peroxide or photoreduction.

To further promote the generation of reactive radicals and sustain the oxidative environment, the reaction mixture is irradiated with near-ultraviolet (UV) light at 365 nm using external lamps for 20 minutes every 3 hours throughout the course of the reaction (typically 9-12 hours in total). This intermittent photoactivation enhances the decomposition of H₂O₂ and facilitates Fe³⁺ photoreduction, thereby sustaining the redox cycling of Fe²⁺/Fe³⁺ and maximizing the generation of hydroxyl radicals without overheating or overexposing the material. The use of pulsed irradiation, rather than continuous exposure, reduces energy consumption and minimizes UV-induced structural damage to the forming GOQDs.

This hybrid chemo-photochemical method results in GOQDs with a high oxidation state, particularly enriched with surface-bound oxygen-containing functional groups such as carboxylic acids and hydroxyl moieties. These functionalities are mainly located at the edges of the quantum dots due to the preferential attack of •OH radicals on defect-prone and reactive zones of the GO lattice. The zeta potential of the resulting GOQDs suspension is consistently below −40 mV, indicating a high density of surface anionic groups and excellent colloidal stability. Such a strong negative surface charge is not only favorable for long-term dispersion stability in polar solvents but also critical for downstream conjugation with cationic molecules, metal ions, or functional polymers.

Characterization by transmission electron microscopy (TEM) confirms that the GOQDs produced via this route exhibit uniform lateral dimensions in the range of 3-6 nm, with monolayer or bilayer thickness confirmed by atomic force microscopy (AFM). Fourier-transform infrared spectroscopy (FTIR) and X-ray photoelectron spectroscopy (XPS) analyses reveal dominant peaks corresponding to C═O, C—O—C, and O—H bonds, consistent with extensive oxidative functionalization. Raman spectra further support the high degree of oxidation and edge disorder, showing a D/G band intensity ratio greater than 1.1.

The inclusion of Fenton chemistry and photochemical enhancement in this embodiment offers a distinct technical advantage over traditional peroxide-based methods. The generation of hydroxyl radicals in-situ allows targeted and highly reactive oxidative cleavage without the need for harsh conditions or aggressive mechanical agitation. The photochemical reinforcement ensures a regenerative radical environment, while the low Fe²⁺ concentration minimizes contamination and post-processing burden. This method provides an efficient, controllable, and scalable pathway to synthesize highly oxidized, edge-functionalized GOQDs with superior dispersibility and chemical reactivity, particularly suitable for sensor fabrication, catalytic applications, or as electron acceptors in nanohybrid systems.

In an embodiment, after 12 hours of oxidative treatment, the mixture is rapidly quenched by immersion in an ice-water bath and immediately subjected to ultrafiltration through a 10 kDa membrane under vacuum, and wherein the retentate is repeatedly washed with chilled deionized water until neutral pH is achieved, and then subjected to centrifugal separation at 14,000 rpm for 20 minutes at 4° C., yielding a pale yellow GOQD suspension exhibiting strong photoluminescence emission at ˜460 nm when excited at 360 nm, confirming quantum confinement and high oxygenation levels.

In this embodiment, the post-oxidative processing of the graphene oxide quantum dots (GOQDs) is carefully orchestrated to ensure both chemical purity and preservation of quantum structural features, which are critical for their intended applications in optoelectronics, bioimaging, or catalytic interfaces. Following the 12-hour oxidative fragmentation of graphene oxide (GO)—typically conducted under peroxide-mediated conditions that cleave GO sheets into nanoscale domains enriched with oxygen functionalities—the reaction is rapidly quenched by immersing the entire reaction vessel in an ice-water bath. This sudden temperature drop not only terminates the oxidative reaction by deactivating reactive intermediates (such as hydroxyl or peroxy radicals) but also stabilizes the structural configuration of the newly formed GOQDs, preventing further over-oxidation or thermal aggregation.

Immediately after quenching, the reaction mixture undergoes ultrafiltration using a 10 kDa molecular weight cutoff (MWCO) membrane, performed under vacuum-driven filtration conditions. This step selectively retains GOQDs while allowing the removal of low molecular weight byproducts including residual hydrogen peroxide, organic acids, unbound ions, and oxidative fragments smaller than the size-exclusion threshold. The use of vacuum-assisted ultrafiltration enhances throughput and minimizes exposure to ambient conditions, which is important for preserving photoluminescent characteristics and minimizing atmospheric contamination.

The retained GOQD fraction, known as the retentate, is then subjected to multiple rinses with chilled deionized water (typically 4-6 cycles), continued until the filtrate reaches a neutral pH (approximately 7.0). This washing is critical for ensuring that no residual acids, peroxides, or ionic species remain, as such contaminants could interfere with both characterization and subsequent conjugation or functionalization processes. The use of chilled water during this step helps maintain the low-temperature stability of the quantum dots and prevents thermally induced aggregation or degradation.

Following purification, the GOQD suspension is subjected to centrifugal separation at 14,000 rpm for 20 minutes at 4° C., a process that helps remove remaining aggregates, large fragments, or colloidal impurities that were not eliminated during filtration. The low temperature of centrifugation further aids in maintaining GOQD dispersity and inhibits any secondary flocculation. The supernatant obtained after centrifugation contains a pale yellow, stable colloidal suspension of GOQDs, indicative of their small particle size and high surface oxidation.

A key hallmark of the resulting GOQD suspension is its strong photoluminescence emission centered at approximately 460 nm, when excited at 360 nm, as measured by fluorescence spectroscopy. This blue-region photoluminescence is a characteristic fingerprint of quantum confinement effects, confirming that the lateral dimensions of the GOQDs are below 10 nm, typically in the range of 3-6 nm. The luminescence also reflects the presence of electronically discrete domains and high oxygen content, particularly due to edge-functionalized carboxylic and hydroxyl groups that modulate the energy levels and promote radiative recombination. The high oxygenation level is further confirmed by X-ray photoelectron spectroscopy (XPS), showing an O/C atomic ratio above 0.4, and the retention of sp² carbon domains is validated via Raman spectroscopy with a D/G intensity ratio above 1.0.

This embodiment provides a technically enabling, non-destructive purification and stabilization strategy for quantum dot production, ensuring that the functional and optical properties of GOQDs are retained after synthesis. The integration of temperature-controlled quenching, membrane ultrafiltration, iterative washing, and cold centrifugation ensures high-purity output without resorting to harsh solvents or extensive post-processing steps. The resulting GOQDs are thus not only monodispersed and optically active but are also chemically pristine and ready for direct use in downstream applications, such as fluorescent sensors, energy-harvesting devices, or hybrid nanocomposite systems requiring tunable optoelectronic response.

In an embodiment, the GO treatment in hydrogen peroxide solution is conducted under oscillatory shear conditions using a programmable vertical shaker set at 150 oscillations per minute with an orbital amplitude of 20 mm to induce dynamic mixing, while simultaneously applying low-power microwave heating at 150 W in 30-second pulses every 10 minutes to selectively disrupt sp² domains and enhance sheet rupture, thereby forming GOQDs with defect-dominated photophysical characteristics and enhanced reactivity toward metal complexation.

In this embodiment, a hybrid mechanical-thermal activation strategy is employed to enhance the oxidative fragmentation of graphene oxide (GO) into graphene oxide quantum dots (GOQDs) with precisely engineered defect structures. The treatment takes place in a reaction vessel containing a dispersion of GO in a hydrogen peroxide solution, and is subject to oscillatory shear forces generated by a programmable vertical shaker operating at 150 oscillations per minute (OPM) with an orbital amplitude of 20 mm. This configuration creates a dynamic fluid environment with alternating flow gradients and micro-vortex formation, which disrupts laminar flow and prevents GO sheet sedimentation, ensuring that all sheets are uniformly exposed to oxidative agents.

Unlike conventional magnetic stirring or static soaking, this oscillatory regime imposes cyclical mechanical strain on the GO sheets, particularly enhancing flexural and torsional deformation. This leads to localized stress concentration at defect-prone areas and oxygenated sites, weakening the carbon lattice and making it more susceptible to chemical attack by the oxidizing peroxide. This mechanical activation is particularly effective for promoting controlled sheet rupture, facilitating the breakdown of large GO sheets into nanoscale domains without relying on sonication or grinding, which may cause random fragmentation and structural collapse.

To further boost the oxidative cleavage while maintaining selectivity, the system is simultaneously subjected to low-power microwave irradiation, delivered in 150 W pulses lasting 30 seconds every 10 minutes throughout the reaction. These intermittent microwave pulses induce localized and volumetric heating through dielectric interaction with polar functional groups on the GO sheets and with water molecules in the reaction medium. The short pulse duration and low power ensure that energy delivery is controlled and targeted, avoiding global temperature rise that could destabilize the quantum dot morphology or lead to undesired aggregation. The microwaves enhance the reactivity of H₂O₂, likely promoting transient formation of hydroxyl radicals (•OH) and facilitating bond scission in the sp² carbon network, particularly at epoxide or hydroxylated domains.

The combination of oscillatory shear and microwave pulses results in the formation of GOQDs characterized by a high density of structural and chemical defects, particularly on the edges and basal planes. These defects include vacancies, edge kinks, carboxylates, and epoxy groups, which are confirmed via high-resolution transmission electron microscopy (HRTEM), X-ray photoelectron spectroscopy (XPS), and Raman spectroscopy, with the latter showing a D/G intensity ratio exceeding 1.2. The high defect density leads to photophysical characteristics dominated by defect-state emission, with photoluminescence peaks typically broadened and red-shifted in comparison to pristine quantum dots, reflecting electronic transitions associated with localized states rather than purely quantum-confinement-induced bandgap transitions.

Moreover, the presence of abundant oxygen-rich defects and π-electron-disrupted domains significantly improves the reactivity of GOQDs toward metal coordination, especially with π-stacked or planar metal complexes such as iron phthalocyanine (FePc). The defect sites serve as nucleation points for non-covalent π-π stacking and metal-ligand bonding, resulting in enhanced interaction strength, uniform dispersion, and higher metal loading efficiency when the GOQDs are used to form nanocomposites.

In an embodiment, the GO suspension is introduced into the peroxide solution using a high-shear inline homogenizer operating at 8000 rpm for 15 minutes to ensure complete dispersion, and wherein during the subsequent oxidation phase, in-situ UV-Vis monitoring of the reaction mixture is performed at 230 nm and 300 nm to track the decrease of extended 71-conjugation and emergence of quantum dot absorption features, respectively, with the process terminated once the absorbance ratio A₃₀₀/A₂₃₀ exceeds 1.8, indicating successful quantum dot formation.

In this embodiment, the oxidative fragmentation process of graphene oxide (GO) into graphene oxide quantum dots (GOQDs) is significantly optimized by leveraging high-shear homogenization in conjunction with real-time UV-Vis spectroscopic monitoring to precisely control the degree of structural transformation. The process begins by introducing the GO suspension into the hydrogen peroxide solution using a high-shear inline homogenizer that operates at 8000 rpm for a continuous duration of 15 minutes. This mechanical action subjects the dispersion to intense fluid shear and turbulence, thereby breaking up any agglomerated GO flakes and ensuring uniform dispersion of GO sheets throughout the oxidizing medium.

This homogenization step serves a dual purpose: first, it maximizes the exposed surface area of GO, facilitating more effective interaction with hydrogen peroxide molecules; second, it ensures that the oxidative reaction proceeds homogeneously across the dispersed nanosheets, avoiding localized overoxidation or incomplete fragmentation. The high-shear environment also introduces transient cavitation zones, which, although less intense than in ultrasonic systems, further contribute to the physical disruption of larger sheets, priming them for chemical scission.

Following homogenization, the oxidation proceeds under controlled thermal or ambient conditions (e.g., 60-65° C.), and the progression of GO fragmentation into quantum dots is continuously monitored using in-situ UV-Vis spectrophotometry. This real-time spectral analysis provides a non-destructive, quantitative readout of the structural evolution of the carbon framework. Specifically, the absorbance at 230 nm is associated with π→π* transitions in aromatic C═C bonds of extended sp² networks, indicative of unfragmented GO sheets. As oxidative cleavage proceeds, this peak diminishes due to the loss of long-range conjugation.

Concurrently, a new absorption feature emerges around 300 nm, corresponding to π→π* transitions of oxygen-containing functional groups and to quantum-confinement-induced edge states characteristic of GOQDs. The ratio of absorbance at these two wavelengths (A₃₀₀/A₂₃₀) serves as a spectral fingerprint for monitoring the transition from large GO sheets to quantum-sized domains. The process is terminated once this ratio exceeds 1.8, a threshold empirically determined to correlate with a high yield of GOQDs having lateral dimensions below 10 nm and rich in carboxyl, hydroxyl, and epoxy functionalities.

The utility of this absorbance ratio as a control metric offers several technical advantages. First, it provides a reliable and reproducible process endpoint that is independent of subjective visual cues or trial-and-error. Second, it allows operators to fine-tune oxidation parameters in real-time—including reaction time, temperature, and peroxide concentration—ensuring batch-to-batch consistency. Third, it enables the minimization of overoxidation, which could otherwise degrade photoluminescent or electronic properties of the GOQDs.

The GOQDs obtained through this method typically exhibit strong colloidal stability in water and polar solvents, owing to their high surface oxidation and small lateral size. Characterization by transmission electron microscopy (TEM) confirms a narrow size distribution (˜3-7 nm), while Fourier-transform infrared spectroscopy (FTIR) and X-ray photoelectron spectroscopy (XPS) confirm the presence of abundant edge-functional groups. Photoluminescence measurements often show emissions centered near 460-480 nm, reflecting both the quantum-confinement effects and the presence of oxygen-related defect states.

In an embodiment, the GO used for generating GOQDs is pre-oxidized using a modified Hummers' method, yielding an oxygen-to-carbon (O/C) atomic ratio above 0.45, and wherein the resultant GOQDs exhibit Raman D-to-G band intensity ratio above 1.1 and distinct UV-Vis absorption peaks at ˜230 nm and ˜300 nm, confirming the disruption of π-conjugation and formation of quantum-confined sp² domains.

In this embodiment, the process begins with the use of pre-oxidized graphene oxide (GO), synthesized via a modified Hummers' method, which is a widely recognized and scalable chemical route for introducing oxygen functionalities into graphite. The modification typically involves the use of potassium permanganate (KMnO₄) in concentrated sulfuric acid (H₂SO₄), often with improved parameters such as lower reaction temperatures, inclusion of phosphoric acid (H₃PO₄), or post-treatment with hydrogen peroxide to enhance oxidation levels while minimizing the introduction of metallic impurities and preserving the integrity of the carbon backbone.

The resulting GO material is characterized by a high oxygen-to-carbon (O/C) atomic ratio above 0.45, which indicates extensive incorporation of oxygen-containing groups such as epoxides, hydroxyls, and carboxyls on both the basal plane and edges of the graphene sheets. This elevated O/C ratio is critical for the downstream fragmentation process, as it renders the GO sheets more chemically labile, particularly at defect-prone and functionalized regions where cleavage into quantum dots is more favorable.

During subsequent peroxide-based oxidative fragmentation, this pre-oxidized GO exhibits greater susceptibility to selective bond cleavage at oxidized zones, facilitating the breakdown of large sheets into nanoscale fragments with well-defined dimensions. Because the initial GO material is already rich in oxygen functionalities, the fragmentation can proceed under milder conditions (e.g., lower temperature, reduced reaction time), reducing the risk of overoxidation, uncontrolled defect formation, or aggregation.

The GOQDs produced from this highly oxidized precursor show distinct structural and spectroscopic signatures. Raman spectroscopy reveals a D-to-G band intensity ratio (I_D/I_G) greater than 1.1, which is indicative of a high degree of disorder and edge defects, consistent with the formation of small, fragmented graphitic domains. The D-band (˜1350 cm⁻¹) corresponds to breathing modes of six-membered rings activated by defects and edges, while the G-band (˜1580 cm⁻¹) corresponds to in-plane vibrational modes of sp²-hybridized carbon atoms. An increased D/G ratio implies successful disruption of extended sp² networks and formation of smaller, defect-rich sp² clusters characteristic of GOQDs.

UV-Vis spectroscopy of the resultant quantum dots further corroborates this structural transformation. Two characteristic absorption peaks are observed: one at ˜230 nm, corresponding to π-π* transitions of aromatic C═C bonds, and a second, broader shoulder at ˜300 nm, attributed to π-π* transitions of oxygenated moieties and quantum confinement effects. The simultaneous appearance of these peaks—along with the relative decrease in intensity of the ˜230 nm peak compared to unfragmented GO—signals the loss of long-range conjugation and the formation of discrete quantum-confined domains.

Importantly, this approach demonstrates that the starting quality and oxidation state of the GO precursor critically determine the efficiency, reproducibility, and quality of the resulting GOQDs. By using a carefully tuned modified Hummers' method to produce a highly oxidized and well-characterized GO feedstock, the downstream process benefits from enhanced fragmentation efficiency, narrower size distribution, and higher surface functionality of the GOQDs. The result is a material ideally suited for applications requiring high aqueous dispersibility, functional group compatibility for conjugation (e.g., with metal complexes like FePc), and tunable photophysical or electrochemical properties.

In an embodiment, after freeze-drying, the GOQDs powder is gently ground using an agate mortar and pestle in a glovebox under dry nitrogen atmosphere to reduce flake stacking and improve redispersibility, and wherein the powder is stored in a desiccator at ≤5% relative humidity and below 10° C. to maintain its reactivity and structural integrity for subsequent conjugation with FePc.

In this embodiment, the post-processing of freeze-dried graphene oxide quantum dots (GOQDs) is carried out under rigorously controlled environmental conditions to ensure preservation of their structural, chemical, and colloidal characteristics prior to functionalization with iron phthalocyanine (FePc). After lyophilization, the resulting GOQDs typically exhibit a highly porous, low-density morphology that, while advantageous for specific surface area, may still undergo partial restacking due to π-π interactions among the graphitic layers or capillary-induced collapse during solvent removal. To address this, the dried GOQDs are gently ground using an agate mortar and pestle within a glovebox maintained under dry nitrogen atmosphere.

The use of an agate mortar is technically significant. Agate is chemically inert, non-abrasive, and free from metallic contamination, ensuring that no extraneous ions or particles are introduced during the grinding process. This is especially critical for quantum dots intended for high-sensitivity applications such as catalysis or sensing, where trace metal contamination could interfere with redox activity or signal transduction. The manual grinding is not intended to fracture the quantum dots but rather to reduce agglomeration, improve powder flowability, and enhance their redispersibility in polar solvents like dimethyl sulfoxide (DMSO) or ethanol, which are commonly used in downstream conjugation or ink formulation steps.

Performing this grinding step in a glovebox with an oxygen level below 1 ppm and relative humidity below 5% serves several purposes. First, it prevents reoxidation of the quantum dots' edge or basal plane functional groups, which may be susceptible to ambient moisture or oxygen—particularly carboxyl, hydroxyl, and epoxide moieties that define the GOQD's reactivity. Second, the inert environment eliminates the risk of adsorbed water altering the surface chemistry or promoting premature hydrolysis or aggregation when the material is reintroduced to solution. Furthermore, low humidity is essential to prevent hygroscopic uptake, which could otherwise change the apparent mass, reduce shelf-life, or introduce inconsistencies in FePc conjugation efficiency.

Once ground, the GOQDs are transferred and stored in a sealed desiccator, held at temperatures not exceeding 10° C., which serves to preserve the material's highly oxygenated, defect-rich state without promoting thermal desorption of volatile groups or inducing structural rearrangement. This storage condition is especially relevant for quantum dots, whose edge and basal plane chemistry directly influence their optical, electronic, and surface interaction behavior. Maintaining a low-temperature, dry environment minimizes physicochemical changes over time, enabling batch consistency and prolonging the usability of the material for precision chemical modifications. This embodiment, while seemingly straightforward, embodies critical process control for preserving the as-synthesized functionality of GOQDs, ensuring that they remain chemically active, structurally intact, and highly dispersible. Such preparation is fundamental to successful integration with FePc, where π-π stacking, electrostatic interactions, or coordination bonding depend on the presence of unaltered carboxylic or hydroxyl functionalities and minimal aggregation.

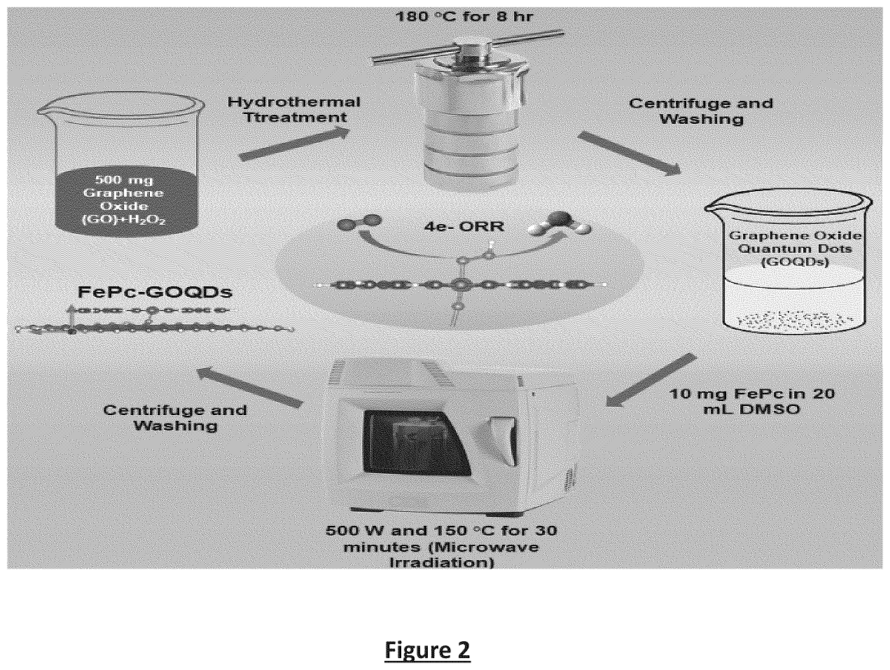

FIG. 2 illustrates a schematic synthesis process for the FePc-GOQDs composite in accordance with an embodiment of the present disclosure. The GOQDs-FePc composite is created utilising a novel hydrothermal-microwave method. This approach allows for the development of strong Fe—O bonds between the iron centre of FePc and the oxygen groups in GOQDs, resulting in significant changes to the electronic structure of the composite. To prepare the composite FePc-GOQDs, 500 mg of graphene oxide (GO) was typically dispersed in a solution of H₂O₂ and deionised water at a 1:10 volume ratio. The solution was subsequently subjected to hydrothermal treatment in a sealed vessel at 180° C. for 8 hr. The final product, GOQDs powder, was acquired through freeze-drying. Subsequently, the prepared 60 mg of GOQDs powder was placed into a microwave reactor together with 10 mg of FePc and 20 mL of DMSO solvent. Additionally, this reactor was placed in a microwave synthesizer at 500 W and 150° C. for 30 minutes. The resultant slurry was rinsed with deionised water and ethanol multiple times, then dried at 120° C. overnight in a hot air oven. The synthesised material was designated as FePc-GOQDs and was commonly utilised for electrochemical investigations and characterisation.

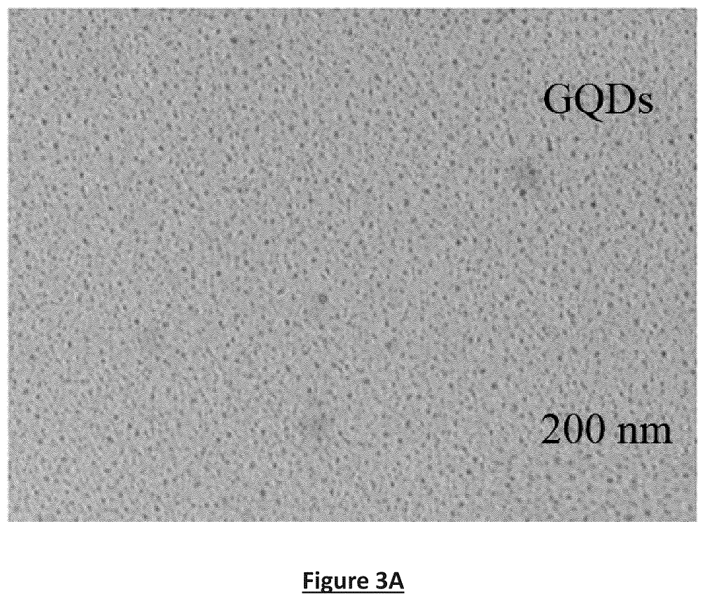

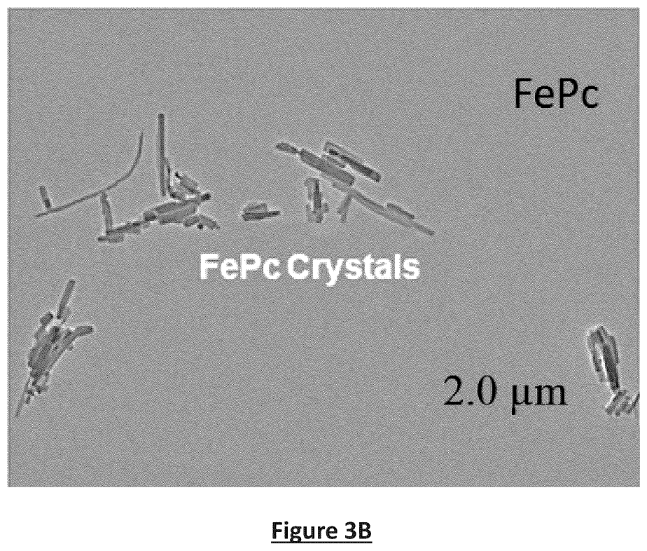

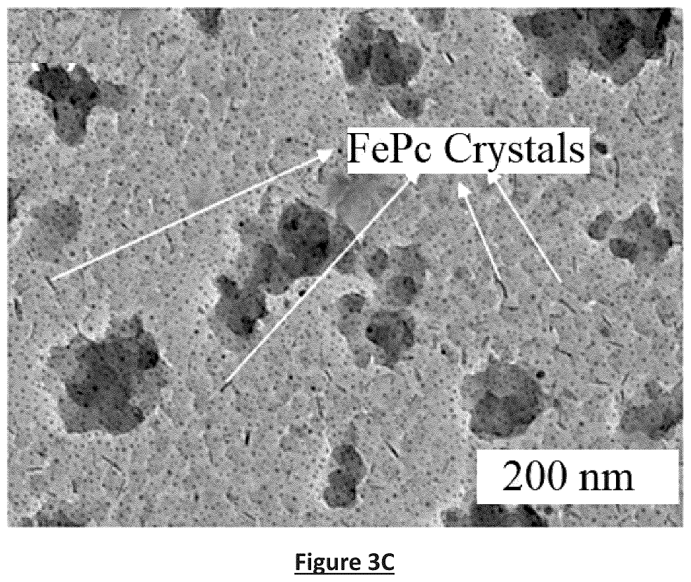

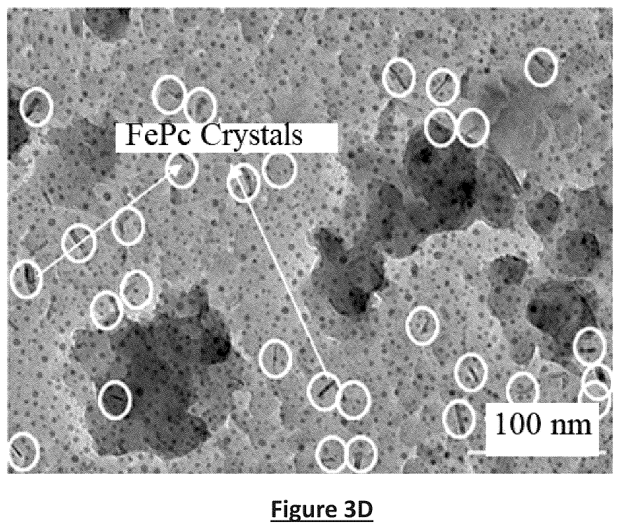

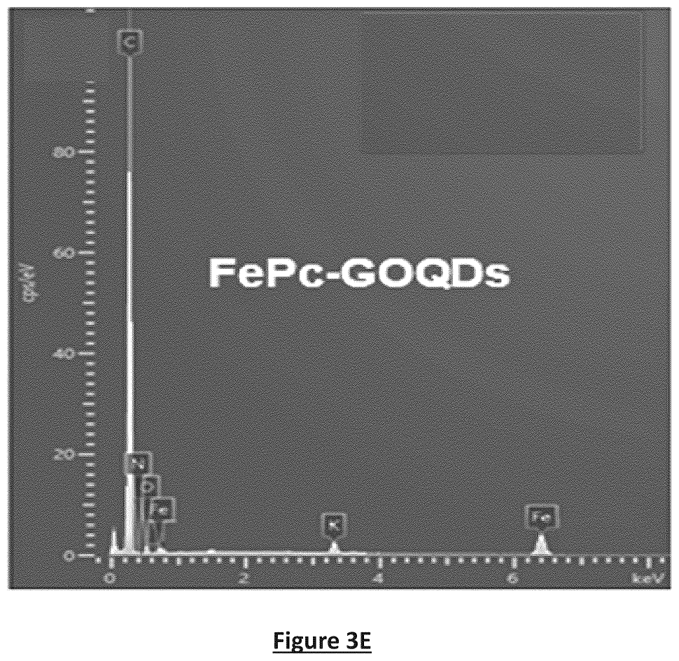

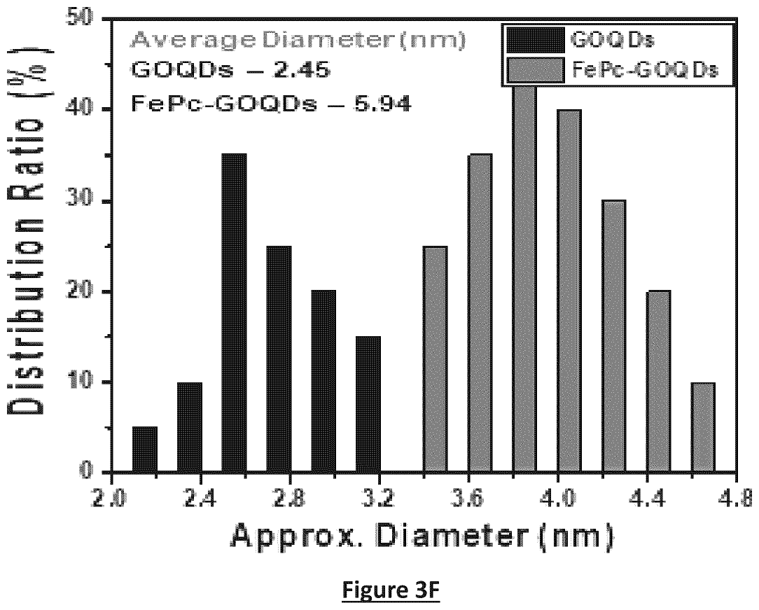

FIG. 3A illustrates a TEM image of the GOQDs, in accordance with an embodiment of the present disclosure.

FIG. 3B illustrates the TEM image of FePc crystal, in accordance with an embodiment of the present disclosure.

FIG. 3C illustrates the TEM image of FePc-GOQDs composite in accordance with an embodiment of the present disclosure.

FIG. 3D illustrates the TEM image of FePc-GOQDs composite in accordance with an embodiment of the present disclosure.

FIG. 3E illustrates EDX spectra of FePc-GOQDs in accordance with an embodiment of the present disclosure.

FIG. 3F illustrates Particle size distribution profile for the GOQDs, and FePc-GOQDs in accordance with an embodiment of the present disclosure.

To gain insight into the material's structure and performance, this invention utilized a variety of characterization techniques such as transmission electron microscopy (TEM), X-ray diffraction (XRD), and electrochemical approaches. TEM was used to examine the shape and dispersion of GOQDs and FePc. XRD was used to determine crystal structure and phase purity. XPS was employed to analyse the composite's bonding states and elemental composition. The characterization results demonstrated the establishment of strong Fe—O connections between FePc and GOQDs. The findings describe how the GOQDs-FePc composite's architecture improves charge transfer and catalytic efficiency. Further, the DFT simulations yielded profound insights, including increased electron density at Fe sites, expedited electron transfer, and a decreased HOMO-LUMO gap.

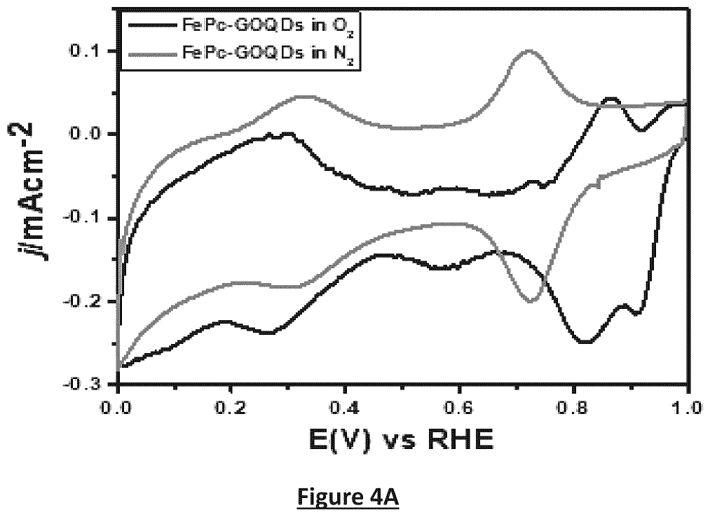

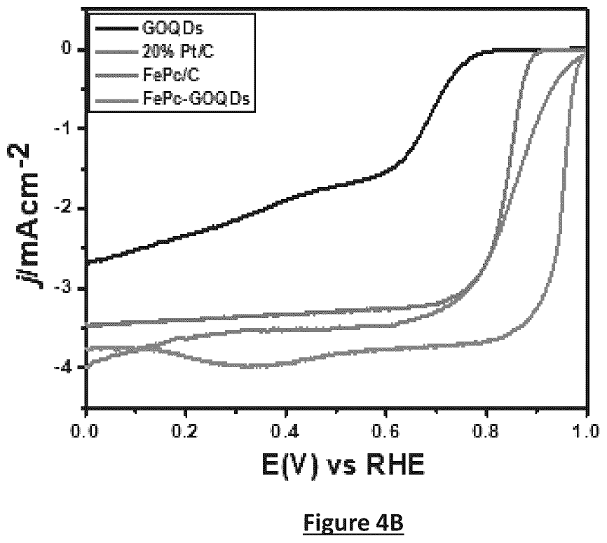

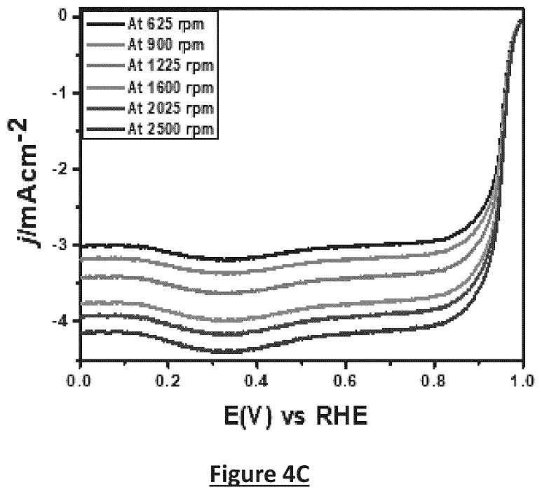

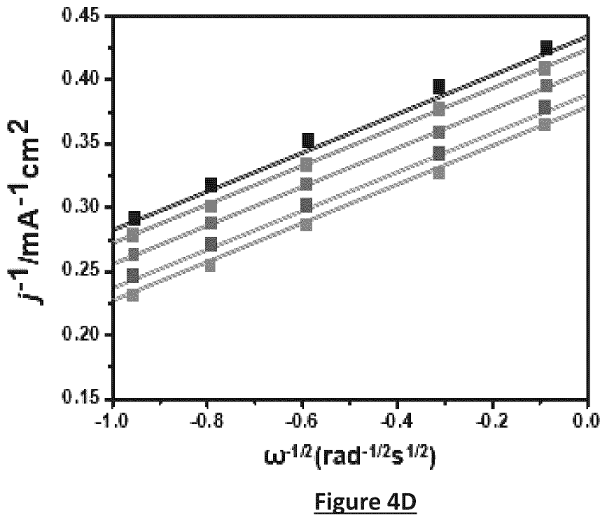

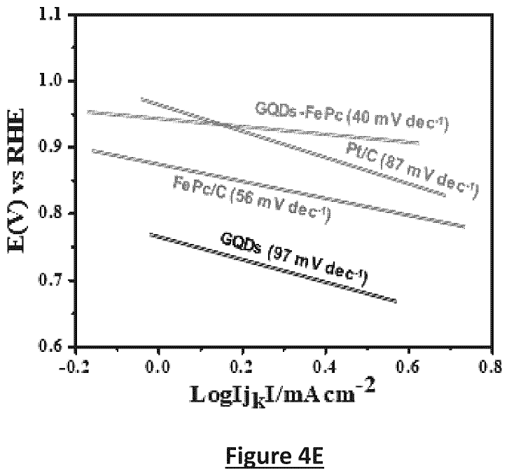

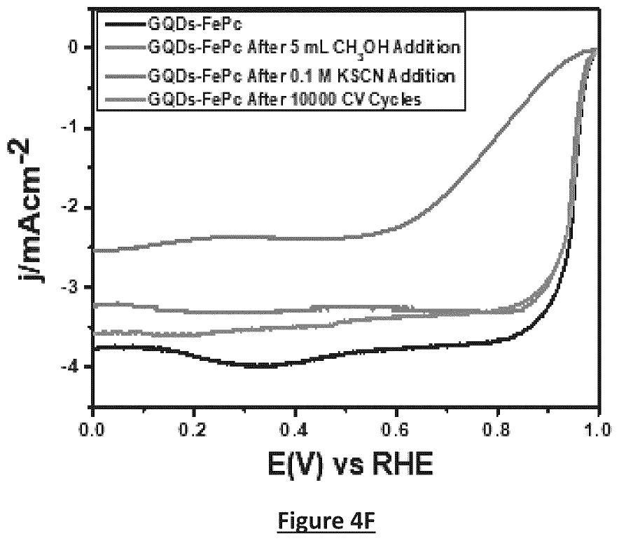

FIG. 4A illustrates CVs of the FePc-GOQDs in presence of O₂ and N₂, recorded in 0.1 M KOH at 50 mV/s scan rate, in accordance with an embodiment of the present disclosure.

FIG. 4B illustrates LSVs of the 20% Pt/C, GOQDs, FePc/C, and FePc-GOQDs in O₂-saturated 0.1 M KOH solution, recorded at 10 mV/s scan rate and 1600 rpm, in accordance with an embodiment of the present disclosure.

FIG. 4C illustrates LSVs of the FePc-GOQDs in O₂-saturated 0.1 M KOH solution, recorded at 10 mV/s scan rate and at various rpm, in accordance with an embodiment of the present disclosure.

FIG. 4D illustrates K-L lots of the FePc-GOQDs composite, in accordance with an embodiment of the present disclosure.

FIG. 4E illustrates Tafel plots for the 20% Pt/C, GOQDs, FePc/C, and FePc-GOQDs, in accordance with an embodiment of the present disclosure.

FIG. 4F illustrates LSVs recorded before and after addition of 5 mL methanol, 1 mL 0.1 M KSCN, and after 10000 CV cycles in accordance with an embodiment of the present disclosure.

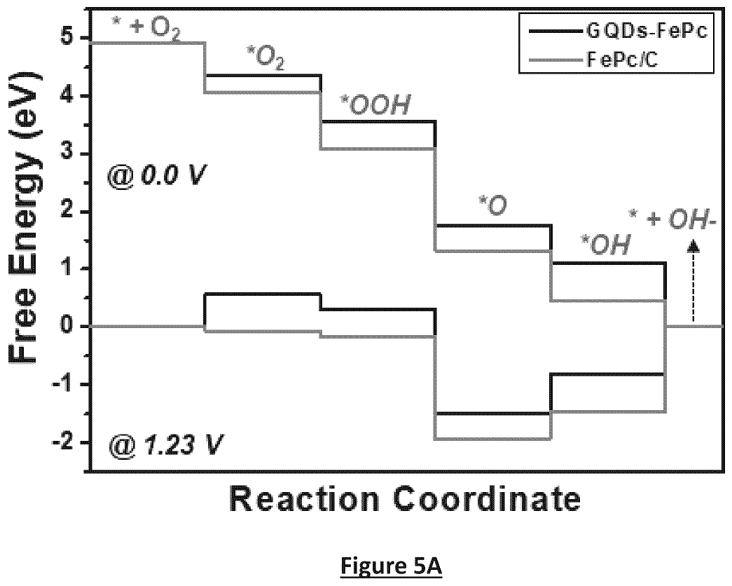

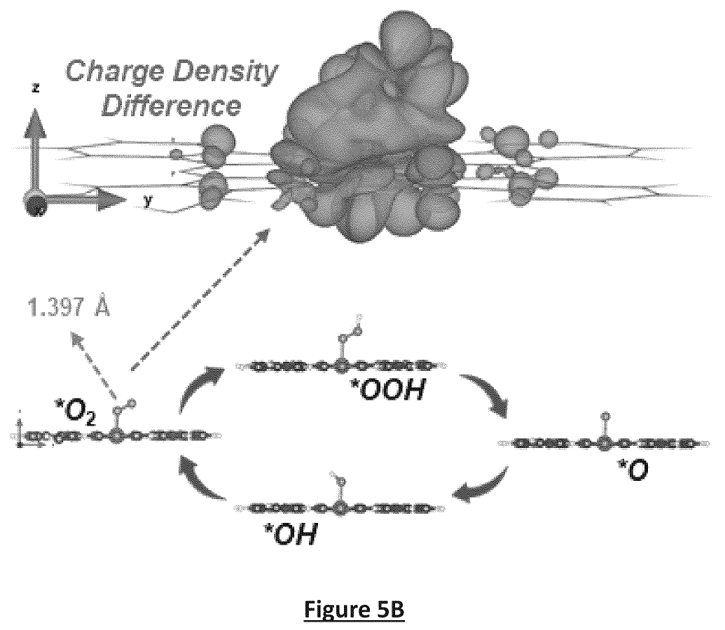

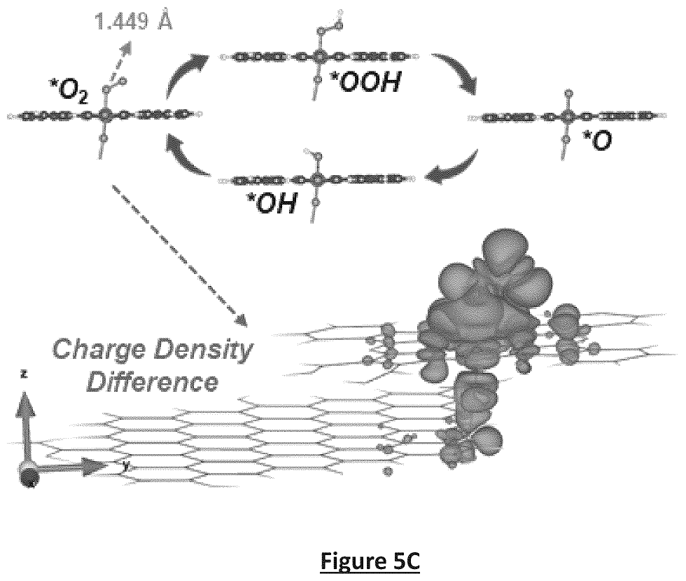

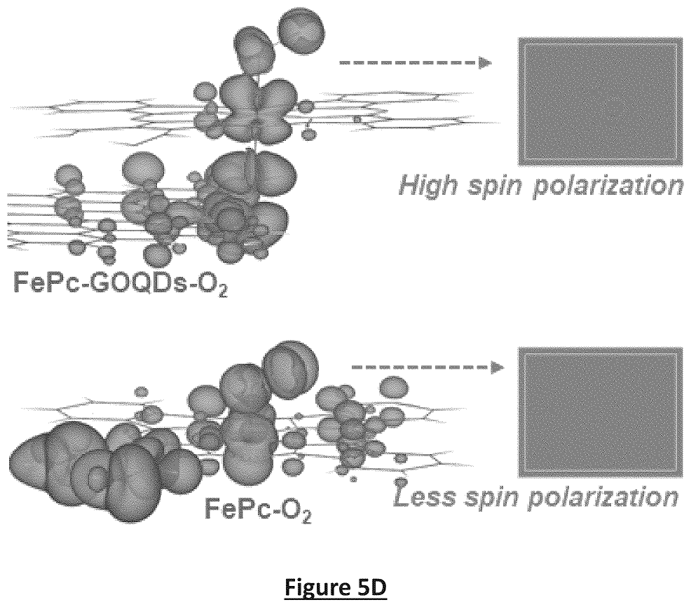

The synthesised GOQDs-FePc composite was subjected to electrochemical tests to assess its performance in ORR, demonstrating its increased efficiency and potential for energy applications. The CV and LSV techniques were used to assess the ORR performance of FePc-GOQDs composite. First, composite CV curves were recorded in 0.1 M KOH solution with and without O2. FePc-GOQDs' CV curve in the absence of O2 (presence of N2) indicated two redox couples at +0.31 V and +0.72 V (vs RHE) for Fe+/Fe2+ and Fe2+/Fe3+ redox processes. In O2, FePc-GOQDs had a robust ORR response peak at +0.92 V and a considerable anodic shift in Fe+/Fe2+ and Fe2+/Fe3+ potential (FIG. 4A). These results showed FePc-GOQDs' significant ORR activity. As shown in FIG. 5b, the LSV curves of GOQDs, 20% Pt/C, bare FePc/C, and FePc-GOQDs were recorded in 0.1 M KOH at 10 mV/s scan rate and 1600 rpm to compare their activity. The FePc-GOQDs composite showed excellent ORR activity, with 300 mV, 100 mV, and 130 mV anodic shifts in half-wave potential (E_{1/2}) compared to GOQDs, 20% Pt/C, and bare FePc/C (FIG. 4B). Because of Fe—O bonding, FePc-GOQDs have a synergistic effect that improves ORR activity. The Fe—O interaction increases electron density at the Fe centre, activating and reducing molecular dioxygen. FIG. 4C and FIG. 4D shows LSV curves at different rotation speeds and their Koutecky-Levich (K-L) plots, which were used to assess electron number during ORR. Results show that ORR optimally uses a 4e-transfer pathway to directly reduce O₂ to water (H₂O). The FePc-GOQDs composite had a smaller Tafel slop (40 mV dec⁻¹) than GOQDs (97 mV dec⁻¹), 20% Pt/C (87 mV dec⁻¹), and bare FePc/C (56 mV dec⁻¹) indicating fast ORR kinetics (FIG. 4E). Further, the results indicated that FePc-GOQDs composite maintained its E1/2 value constant but loosed 0.31 mA/cm² current density, indicating its remarkable ability towards methanol tolerance (FIG. 4F).

FIG. 5A illustrates ORR Gibbs free energy profile for the pristine FePc, and FePc-GOQDs in accordance with an embodiment of the present disclosure.

FIG. 5B illustrates ORR mechanism on pristine FePc along with charge density difference over the FePc-O₂ adduct in accordance with an embodiment of the present disclosure.

FIG. 5C illustrates ORR mechanism on FePc-GOQDs along with charge density difference over the FePc-GOQDs-O₂ adduct in accordance with an embodiment of the present disclosure.

FIG. 5D illustrates Spin polarization profile over the FePc-O₂, FePc-GOQDs-O₂ adducts in accordance with an embodiment of the present disclosure.

The theoretical investigations into spin polarisation revealed optimal conditions for O2 adsorption and reduction, whilst Gibbs free energy assessments demonstrated that the synergistic Fe—O bonding substantially reduced energy barriers in critical ORR stages. This study not only develops a high-performance electrocatalyst but also introduces a framework for customising FePc molecules via strategic engineering of the Fe—O link as a fifth ligand attachment. This approach can be expanded to include FePc with oxygen- or nitrogen-functionalized nanocarbon materials or other conductive platforms, facilitating the development of next-generation energy materials with enhanced catalytic performance. FIG. 5A, FIG. 5B, FIG. 5C, and FIG. 5D showed the ORR Gibbs free energy profile, ORR mechanism, ORR mechanism on FePc-GOQDs along with charge density difference over the FePc-GOQDs-O₂ adduct, and spin polarization profile over the FePc-O₂, FePc-GOQDs-O₂ adducts, respectively.

The invention is in the field of electrocatalysis with a specific focus on the creation of efficient materials to improve the ORR performance. This involves combining nanomaterials, such as graphene oxide quantum dots (GOQDs) with the transition metal complexes, such as iron phthalocyanine (FePc) to build composite materials that improve the efficiency and efficacy of catalytic ORR process in fuel cells.

The invention has numerous applications, including renewable energy technologies like as fuel cells and metal-air batteries, where effective ORR catalysis is crucial for energy conversion and storage. By investigating the structural and electronic alterations made by such composites, the invention adds to the larger domains of energy materials, nanotechnology, and electrochemistry, with the goal of addressing issues in the creation of sustainable energy solutions.

The invention introduces a new composite material, GOQDs-FePc, which is specifically developed to improve the efficiency of ORR, which is critical for fuel cells and metal-air batteries.

The key findings about the composite's structure are (i) the hybrid structure of uniformly dispersed GOQDs and FePc nanocrystals improves electrocatalytic efficiency, (ii) strong Fe—O bonding increases the electrical environment at active sites, allowing for quicker electron transport, (iii) C, N, O, and Fe promote effective surface contacts for catalysis, and (iv) Nanocrystalline structure enhances surface area and active site accessibility.

The key findings about the electrocatalytic ORR performance are (i) the electrocatalytic ORR activity of GOQDs-FePc is superior than bare FePc and standard 20% Pt/C catalysts, (ii) the durability of GOQDs-FePc is superior than bare FePc and standard 20% Pt/C catalysts, (ii) methanol tolerance of GOQDs-FePc is superior than bare FePc and standard 20% Pt/C catalysts.

The key findings of the theoretical studies are (i) lower Gibbs free energy barriers for GOQDs-FePc composite as compared to bare FePc improved its ORR activity, (ii) Improved electronic and catalytic performance of the GOQDs-FePc composite was due to the synergistic Fe—O bond between GOQDs and FePc.

The graphene oxide quantum dots-iron phthalocyanine (FePc-GOQDs) nanocomposite synthesized through the disclosed process exhibits excellent potential across a variety of energy and sensing technologies. One of the primary applications lies in electrocatalysis for fuel cells, where the material serves as a highly efficient and durable catalyst for the oxygen reduction reaction (ORR), improving energy conversion efficiency. Additionally, the nanocomposite can be utilized in electrochemical sensors due to its high surface area, conductivity, and reactive surface sites, enabling sensitive and selective detection of chemical and biological analytes.

The material also finds strong applicability in metal-air batteries, where its high ORR activity enhances the performance and longevity of the cathodic process. Moreover, it is well-suited for integration into renewable energy systems, supporting the development of cleaner and more sustainable energy solutions. Another notable application is in water splitting, where the composite may be used as an electrocatalyst to drive key reactions, contributing to hydrogen production from water.

The invention offers several distinct advantages over existing catalytic materials. Firstly, it provides enhanced catalytic performance, particularly in oxygen reduction, surpassing traditional catalysts like bare FePc and 20% Pt/C in both activity and efficiency. The composite also exhibits improved stability and durability, maintaining functionality over prolonged use and in the presence of contaminants like methanol.

The synthesis process is scalable and cost-effective, utilizing readily available precursors and microwave-assisted techniques that are suitable for large-scale production. The presence of quantum dots introduces quantum confinement effects, which contribute to superior electronic and optical properties. Furthermore, the strong Fe—O bonding and hybrid nanostructure result in tailored electronic properties, enabling fine-tuned catalytic behavior. Finally, the material's unique characteristics enable its use in a versatile range of applications, making it a promising candidate for next-generation energy and sensing technologies.

The hydrothermal-microwave synthesis process used to make the GOQDs-FePc composite can be claimed, emphasizing its efficiency and scalability for creating high-quality nanomaterials.

The GOQDs-FePc composite has a distinct structural composition, consisting of uniformly dispersed GOQDs and nanocrystalized FePc with a desired strong Fe—O bonding connection. The Graphene Oxide serves as a substrate forming pi=pi stacking with the Quantum Dots, making it stable and fixed. These structural features are believed to improve the final material's electrochemical characteristics and stability.

The composite significantly improves electrocatalytic activity of ORR, as evidenced by an anodic shift in half-wave potential (E_{1/2}) compared to pristine FePc and commercially available Pt/C catalyst. Thus, it is establishing itself as a highly efficient electrocatalyst.

The GOQDs-FePc composite maintains electrocatalytic performance over extensive cycling (e.g., 10,000 cycles) without substantial deterioration, claiming improved durability and stability.

The interaction between GOQDs and FePc, according to the invention, optimises the electronic properties of the composite, including an increase in charge density at the Fe sites, a smaller HOMO-LUMO gap, and a favourable Gibbs free energy for the ORR, resulting in lower energy barriers during reaction steps.

An efficient optimum ORR electrocatalyst for proton exchange membrane fuel cell.

The creation of the GOQDs-FePc composite marks a substantial advance in electrocatalysis, notably for oxygen reduction reactions (ORR). The rigorous synthesis method utilising hydrothermal-microwave techniques demonstrates the efficacy of this strategy in establishing robust connections between graphene oxide quantum dots (GOQDs) and iron phthalocyanine (FePC). The creation of strong Fe—O bonds is essential for strengthening the electrical interactions inside the composite, which are critical for improving catalytic activity.

The composite's extensive characterisation reveals that its structural and morphological features are well-suited to electrocatalytic applications. X-ray photoelectron spectroscopy (XPS) and transmission electron microscopy (TEM) have confirmed the successful hybridisation of GOQDs and FePc, revealing a uniform distribution of the components, which is critical for maximising active sites and ensuring efficient charge transfer. The investigation shows that the interaction between FePc with GOQDs considerably alters the electronic environment, resulting in increased charge transport efficiency.

Furthermore, the spectrum changes observed in UV-Vis and FTIR experiments support the strong electronic interaction between the oxygen functional groups of GOQDs and the iron centres of FePc. These improvements not only reduce the energy barriers associated with the ORR, but also improve the composite's stability and durability in practical applications, both of which are crucial for the long-term operation of electrochemical devices.

The consequences of this research go beyond the immediate findings; it paves the way for the development of high-performance electrocatalysts that take advantage of hybrid materials' unique features. This study presents a paradigm for generating sustainable energy materials that could considerably improve the efficiency of fuel cells and metal-air batteries, contributing to advances in renewable energy technologies. The GOQDs-FePc composite demonstrates how new synthesis and characterisation methodologies can result in improved electrocatalysts. This discovery not only increases our understanding of the material interactions at work, but it also encourages additional research into hybrid systems with high conductivity, stability, and enhanced catalytic characteristics, indicating a promising direction in energy conversion technology.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A process for synthesizing a graphene oxide quantum dots-iron phthalocyanine (FePc-GOQDs) nanocomposite, comprising:
producing graphene oxide quantum dots (GOQDs) upon treating 500 mg of graphene oxide (GO) in a solution comprising hydrogen peroxide (H₂O₂) and deionized water in a 1:10 volume ratio;
freeze-drying the resultant GOQDs to obtain GOQDs powder;
mixing 60 mg of the GOQDs powder with 10 mg of iron phthalocyanine (FePc) and 20 mL of dimethyl sulfoxide (DMSO);
subjecting the mixture to microwave irradiation at a power of 500 W and a temperature of approximately 150° C. for 30 minutes in a microwave synthesizer to form a nanocomposite;
rinsing the obtained slurry with deionized water and ethanol multiple times; and
drying the rinsed material at approximately 120° C. for an extended duration to yield the FePc-GOQDs nanocomposite;
wherein the freeze-drying step is performed under vacuum conditions to preserve the quantum dot morphology, and wherein the drying step is carried out in a hot air oven for approximately 12 hours; and wherein the GOQDs production comprising:
dispersing 500 mg of graphene oxide (GO) in a solution comprising hydrogen peroxide (H₂O₂) and deionized water in a 1:10 volume ratio; and
subjecting the dispersion to hydrothermal treatment in a sealed vessel at a temperature of approximately 180° C. for a duration of 8 hours to produce GOQDs; and
wherein after the 12-hour oxidative fragmentation, the resulting GOQDs suspension is centrifuged at 13,000 rpm for 25 minutes at 4° C. to remove unreacted GO and larger particulates, and the supernatant containing colloidally dispersed GOQDs is subjected to dialysis using a 1 kDa molecular weight cutoff (MWCO) cellulose membrane against deionized water for 72 hours with water replaced every 8 hours to remove residual H₂O₂, peroxy-acids, and low-molecular-weight impurities.

2. The process of claim 1, wherein the freeze-drying is preceded by pre-concentration of the GOQDs solution via rotary evaporation at 40° C. under reduced pressure (400 mbar) to achieve a 5× concentration, followed by immediate snap-freezing using liquid nitrogen immersion for 3 minutes to prevent GOQDs aggregation and structural rearrangement, and wherein the freeze-drying is conducted in a programmable lyophilizer with ramped shelf temperatures from −40° C. to +20° C. over 48 hours under a vacuum of <0.05 mbar to yield a fine, free-flowing powder with a specific surface area greater than 100 m²/g, and wherein the freeze-dried GOQDs are stored in an inert argon-purged glove box with controlled humidity <5% RH and oxygen level below 1 ppm to prevent surface reoxidation or contamination prior to re-dispersion in DMSO for nanocomposite formulation with FePc.

3. The process of claim 1, wherein said graphene oxide quantum dots-iron phthalocyanine (FePc-GOQDs) nanocomposite comprises:
60 mg of graphene oxide quantum dots (GOQDs);
10 mg of iron phthalocyanine (FePc); and
20 mL of dimethyl sulfoxide (DMSO); wherein the GOQDs powder comprising:
500 mg of graphene oxide (GO);
hydrogen peroxide (H₂O₂); and
deionized water.

4. The process of claim 1, wherein the drying step is carried out in a hot air oven for approximately 12 hours, and wherein the GOQDs powder is re-dispersed in DMSO at a concentration of 2.5 mg/mL and sonicated using a probe sonicator at 20 kHz and 180 W for 30 minutes in an ice bath to maintain the temperature below 25° C., followed by dropwise addition of FePc solution at a molar ratio of 1:3 (FePc:GOQD edge functional groups) and further sonication for 45 minutes in pulse mode to facilitate uniform non-covalent π-π stacking interactions and metal-ligand bonding.

5. The process of claim 1, wherein the treatment of 500 mg of graphene oxide (GO) in a hydrogen peroxide (H₂O₂) and deionized water solution in a 1:10 volume ratio is performed by dispersing the GO in the aqueous phase under magnetic stirring at 600 rpm for 30 minutes to form a stable colloidal suspension, followed by dropwise addition of 30% w/v hydrogen peroxide under ice-cooled conditions to control exothermicity, and wherein the reaction is subsequently maintained at 65° C. for 12 hours in a closed reflux system with intermittent sonication at 40 kHz for 10 minutes every 2 hours to facilitate oxidative cleavage of the GO sheets into nanoscale GOQDs with an average lateral size of 3-8 nm and a thickness below 3 atomic layers.

6. The process of claim 1, wherein prior to freeze-drying, the purified GOQDs dispersion is concentrated using rotary evaporation at 35° C. under a vacuum of 250 mbar to reduce the water volume to one-fifth its original volume, and wherein the concentrated solution is flash-frozen by immersion in liquid nitrogen for 2 minutes to preserve the nanoarchitecture and prevent aggregation, followed by storage at −80° C. for a minimum of 4 hours before freeze-drying, and wherein the freeze-drying of GOQDs is carried out using a programmable lyophilizer with an initial primary drying phase at −45° C. and 0.02 mbar vacuum for 24 hours, followed by a secondary drying phase involving a gradual increase in shelf temperature to 20° C. over 10 hours under sustained vacuum to ensure removal of bound water, resulting in a porous, loosely aggregated GOQDs powder with a bulk density below 0.08 g/cm³ and a retained oxygen content above 25 wt %.

7. The process of claim 1, wherein the hydrogen peroxide and deionized water solution used to treat 500 mg of graphene oxide (GO) is first preconditioned by adjusting the pH to 3.5 using dilute sulfuric acid, and wherein the treatment is performed under a closed reflux system at 65° C. for 10 hours with constant magnetic stirring at 500 rpm, followed by rapid cooling to 4° C. to quench the oxidation reaction and stabilize the quantum dot dimensions between 3-8 nm, and wherein the oxidative treatment further enhances edge-plane carboxylation for improved conjugation with FePc.

8. The process of claim 1, wherein the GOQDs are purified post-treatment using a sequential multi-step filtration strategy involving ultracentrifugation at 15,000 rpm for 25 minutes, followed by vacuum-assisted filtration through a 0.1 μm membrane and subsequent dialysis against deionized water using a 1,000 Da MWCO membrane over 72 hours to eliminate residual ions, peroxide remnants, and partially oxidized graphitic species prior to freeze-drying.

9. The process of claim 1, wherein the mixture of FePc and GOQDs in DMSO is stirred at 300 rpm at 60° C. for 4 hours under a nitrogen blanket to allow thermodynamically favorable self-assembly and ensure maximum dispersion stability, and wherein zeta potential analysis is conducted to confirm nanocomposite stability in suspension with a surface charge below −35 mV.

10. The process of claim 1, wherein the microwave irradiation of the FePc-GOQDs-DMSO mixture is carried out using a single-mode microwave synthesis system operating at 2.45 GHz with temperature feedback control, wherein the reaction chamber is maintained at 80° C. for 10 minutes at a power of 250 W, and wherein the ramp-up and hold phases are optimized to favor interfacial coordination between iron centers and GOQDs carboxyl sites without thermal degradation of either component, and wherein the microwave-assisted reaction is followed by a slow cooling phase inside the reactor to 30° C. over 60 minutes under continuous nitrogen purge, and wherein the resultant product is immediately filtered through a 0.1 μm PVDF membrane and washed successively with acetone, methanol, and water in a 1:1:2 ratio to remove unreacted FePc and DMSO.

11. The process of claim 1, wherein the FePc-GOQDs nanocomposite is dispersed in ethanol to prepare an ink formulation with 0.5 wt % Nafion as a binder and deposited on glassy carbon electrodes via drop-casting for electrochemical evaluation, wherein cyclic voltammetry in 0.1 M KCl shows a quasi-reversible redox couple attributed to Fe(II)/Fe(III) transition, indicating electroactive FePc anchoring.

12. The process of claim 1, wherein the hydrogen peroxide and deionized water solution used to treat the graphene oxide is pre-mixed in a volumetric ratio of 1:10 and degassed by ultrasonication at 40 kHz for 15 minutes prior to the addition of GO, and wherein the treatment is initiated by gradually introducing the GO powder under vigorous stirring at 800 rpm over a period of 30 minutes to prevent localized exothermic hotspots, with the mixture maintained at 65±0.5° C. using a PID-controlled water circulator and simultaneously exposed to blue LED illumination (wavelength 450 nm, 5 mW/cm²) for photochemically enhanced peroxide activation, resulting in more uniform oxidative fragmentation of the GO sheets into sub-10 nm quantum dots.

13. The process of claim 1, wherein the treatment of GO in H₂O₂ and deionized water is carried out in a double-jacketed glass reactor equipped with an overhead mechanical stirrer operating at 650 rpm and a reflux condenser to minimize evaporative loss, and wherein the oxidation reaction is initiated under an inert nitrogen purge at 1 L/min for 15 minutes followed by reaction under ambient atmosphere for 10 hours, and wherein the temperature is precisely modulated between 60° C. and 70° C. in 30-minute cycles to create thermal shock conditions that accelerate the formation of edge defects and oxygenated sites on the resulting GOQDs; and wherein the GO is pretreated by mild acidification with 0.01 M HCl followed by vacuum drying at 60° C. for 4 hours prior to the peroxide-water treatment, and wherein during oxidative fragmentation the system is maintained at a constant pH of 3.8 using a titration pump dispensing dilute H₂SO₄, while a microbubble air sparger introduces air at a rate of 50 mL/min to promote cavitation-enhanced fragmentation and the formation of circular GOQD domains with narrow size distribution and increased oxygen content at edge sites.

14. The process of claim 1, wherein the oxidative fragmentation of GO is enhanced by the in-situ generation of hydroxyl radicals (•OH) via activation of H₂O₂ in the presence of trace iron ions (Fe²⁺, 0.01 mM) introduced as FeSO₄·7H₂O to promote a Fenton-like reaction, wherein the mixture is stirred at 600 rpm and irradiated with near-UV light (365 nm) for 20 minutes every 3 hours, resulting in GOQDs with higher oxidation state and a zeta potential below −40 mV due to dense surface carboxylation; and wherein after 12 hours of oxidative treatment, the mixture is rapidly quenched by immersion in an ice-water bath and immediately subjected to ultrafiltration through a 10 kDa membrane under vacuum, and wherein the retentate is repeatedly washed with chilled deionized water until neutral pH is achieved, and then subjected to centrifugal separation at 14,000 rpm for 20 minutes at 4° C., yielding a pale yellow GOQD suspension exhibiting strong photoluminescence emission at ˜460 nm when excited at 360 nm, confirming quantum confinement and high oxygenation levels.

15. The process of claim 1, wherein the GO treatment in hydrogen peroxide solution is conducted under oscillatory shear conditions using a programmable vertical shaker set at 150 oscillations per minute with an orbital amplitude of 20 mm to induce dynamic mixing, while simultaneously applying low-power microwave heating at 150 W in 30-second pulses every 10 minutes to selectively disrupt sp² domains and enhance sheet rupture, thereby forming GOQDs with defect-dominated photophysical characteristics and enhanced reactivity toward metal complexation; and wherein the GO suspension is introduced into the peroxide solution using a high-shear inline homogenizer operating at 8000 rpm for 15 minutes to ensure complete dispersion, and wherein during the subsequent oxidation phase, in-situ UV-Vis monitoring of the reaction mixture is performed at 230 nm and 300 nm to track the decrease of extended π-conjugation and emergence of quantum dot absorption features, respectively, with the process terminated once the absorbance ratio A₃₀₀/A₂₃₀ exceeds 1.8, indicating successful quantum dot formation.

16. The process of claim 1, wherein the GO used for generating GOQDs is pre-oxidized using a modified Hummers' method, yielding an oxygen-to-carbon (O/C) atomic ratio above 0.45, and wherein the resultant GOQDs exhibit Raman D-to-G band intensity ratio above 1.1 and distinct UV-Vis absorption peaks at ˜230 nm and ˜300 nm, confirming the disruption of π-conjugation and formation of quantum-confined sp² domains; and wherein after freeze-drying, the GOQDs powder is gently ground using an agate mortar and pestle in a glovebox under dry nitrogen atmosphere to reduce flake stacking and improve redispersibility, and wherein the powder is stored in a desiccator at ≤5% relative humidity and below 10° C. to maintain its reactivity and structural integrity for subsequent conjugation with FePc.
